(19) United States
(12) Patent Application Publication
(10) Pub. No.: US 2018/0343701 A1
(43) Pub. Date: Nov. 29, 2018

(54) Communication Link Establishment Method, Protocol Stack, Terminal, and Network Device

(71) Applicant: Huawei Technologies Co., Ltd., Shenzhen (CN)

(72) Inventors: Jie Ma, Shenzhen (CN); Bo Lin, Beijing (CN)

(21) Appl. No.: 16/054,660

(22) Filed: Aug. 3, 2018

Related U.S. Application Data
(63) Continuation of application No. PCT/CN2016/073565, filed on Feb. 4, 2016.

(51) Int. Cl. H04W 80/02; H04W 76/10; H04W 76/27; H04W 28/02

(52) U.S. Cl. CPC H04W 80/02; H04W 76/10; H04W 4/80; H04W 28/0268; H04W 76/27

(57) ABSTRACT

Embodiments of the present application provide a communication link establishment method. The method includes: A first terminal establishes a connection to a network device by using a second terminal; the network device delivers configuration information; and the first terminal and the second terminal separately determine link configuration information, and establish a preset-protocol-based communication link between the first terminal and the second terminal based on the link configuration information. The preset-protocol-based communication link and a cellular network communication link are jointly used by the first terminal to transmit a packet with the network device by using the second terminal.

### CROSS-REFERENCE TO RELATED APPLICATIONS

This application is a continuation of International Application No. PCT/CN2016/073565, filed on Feb. 4, 2016, the disclosure of which is hereby incorporated by reference in its entirety.

### TECHNICAL FIELD

The present application relates to the wireless communications field, and in particular, to a communication link establishment method, a protocol stack, a terminal, and a network device.

### BACKGROUND

With vigorous development of wearable equipment (WE), the wearable equipment is widely applied in people's daily life. The wearable equipment may upload data obtained by the wearable equipment to a network device by using a relay device, so that the network device can provide a service for the wearable equipment. For example, the data obtained by the wearable equipment includes physiological data of a wearer obtained by the wearable equipment. The relay device may be an intelligent mobile terminal of the wearer of the wearable equipment. The wearable equipment may also be used as a convenient portable communication tool, to provide the wearer with services such as SMS message receiving, time checking, and location positioning. For example, the wearable equipment includes smart glasses, a smart band, a smartwatch, smart shoes, and the like.

In the prior art, wearable equipment cannot directly communicate with a network device in a cellular network in consideration of characteristics of the wearable equipment, to be specific, a small size, a small battery capacity, and low power consumption. The wearable equipment needs to use a relay device to communicate with the network device in the cellular network. In a process in which the wearable equipment uses the relay device to communicate with the network device in the cellular network, the wearable equipment sends a packet to the relay device, and the relay device performs parsing processing on the packet at an application (APP) layer to generate a new packet, and sends the packet newly generated at the APP layer to the network device.

Based on the prior art, the network device can identify that the received packet is sent by the relay device, but cannot identify that the packet sent by the relay device is sent by the wearable equipment. As a result, the network device cannot directly manage the wearable equipment and cannot provide a value-added service for the wearable equipment. In addition, the prior art has a security risk. For example, a listener may listen to a process in which the wearable equipment negotiates with the relay device about a key used for packet transmission. The listener may use the key obtained through listening to crack the packet transmitted between the wearable equipment and the relay device, causing a security risk to the packet. For another example, in a process in which the wearable equipment sends the packet to the APP layer of the relay device and the APP layer parses the packet to generate the new packet, a malicious program may exist inside the relay device to obtain the packet. This also causes a security risk to the packet.

### SUMMARY

Embodiments of the present application provide a communication link establishment method, a protocol stack, a terminal, and a network device, to establish a communication link between wearable equipment and a network device, so that the network device can directly manage the wearable equipment, and a security risk is reduced in a process in which the wearable equipment communicates with the network device by using a relay device.

According to a first aspect, an embodiment of the present application provides a communication link establishment method. The method includes establishing, by a first terminal, a connection to a network device by using a second terminal, where a cellular network communication link has been established between the second terminal and the network device. The method further includes determining, by the first terminal, link configuration information, and establishing, based on the link configuration information, a preset-protocol-based communication link with the second terminal. The preset protocol is a Bluetooth protocol or a Wireless Fidelity WiFi protocol, and the preset-protocol-based communication link and the cellular network communication link are jointly used by the first terminal and the second terminal to transmit a packet to the network device by using the second terminal. In a process in which the first terminal transmits a packet with the network device by using the second terminal, the first terminal and the second terminal both have a packet conversion function. The packet conversion function converts the transmitted packet between a preset-protocol-based packet and a cellular network packet.

With reference to the first aspect, in a first possible implementation, the determining, by the first terminal, link configuration information includes: receiving, by the first terminal, configuration information that is of a radio bearer and that is sent by the network device, and generating, by the first terminal, the link configuration information based on the configuration information of the radio bearer. The radio bearer is a radio bearer between the first terminal and the network device. Alternately, the determining comprises receiving, by the first terminal, the link configuration information sent by the network device. Alternately, the determining comprises receiving, by the first terminal, the link configuration information sent by the second terminal; or generating, by the first terminal, the link configuration information based on preconfigured information.

With reference to the first aspect or the first possible implementation of the first aspect, in a second possible implementation of the first aspect, after the establishing, by the first terminal, a preset-protocol-based communication link with the second terminal, the method further includes transmitting, by the first terminal, a packet with the network device by using the second terminal.

With reference to the second possible implementation of the first aspect, in a third possible implementation of the first aspect, the transmitting, by the first terminal, a packet with the network device by using the second terminal includes: converting, by the first terminal, a cellular network packet generated by a cellular network module into a preset-protocol-based packet; and sending, by the first terminal, the preset-protocol-based packet to the second terminal through the preset-protocol-based communication link, so that after converting the received preset-protocol-based packet into the cellular network packet, the second terminal sends the cellular network packet to the network device through the cellular network communication link.

With reference to the second or the third possible implementation of the first aspect, in a fourth possible implementation of the first aspect, the transmitting, by the first terminal, a packet with the network device by using the second terminal includes: receiving, by the first terminal, a preset-protocol-based packet of the second terminal through the preset-protocol-based communication link, where the preset-protocol-based packet is obtained by the second terminal by converting a cellular network packet, and the cellular network packet is sent by the network device to the second terminal through the cellular network communication link; and converting, by the first terminal, the preset-protocol-based packet into the cellular network packet, and transferring the cellular network packet to the cellular network module for processing.

According to a second aspect, an embodiment of the present application provides a communication link establishment method. The method includes establishing, by a network device, a connection to a first terminal by using a second terminal, where the connection establishes a cellular network communication link between the second terminal and the network device. The method further includes delivering, by the network device, configuration information, where the configuration information is used to establish a preset-protocol-based communication link between the first terminal and the second terminal. The preset protocol is a Bluetooth protocol or a Wireless Fidelity WiFi protocol, and the preset-protocol-based communication link and the cellular network communication link are jointly used by the first terminal and the second terminal to transmit a packet to the network device by using the second terminal. In a process in which the first terminal transmits a packet with the network device by using the second terminal, the first terminal and the second terminal both have a packet conversion function, and the packet conversion function is to convert the transmitted packet between a preset-protocol-based packet and a cellular network packet.

With reference to the second aspect, in a first possible implementation, the establishing, by a network device, a connection to a first terminal by using a second terminal includes: receiving, by the network device by using the second terminal, a request message sent by the first terminal, where the request message is used by the first terminal to request to establish a connection to the network device.

With reference to the second aspect or the first possible implementation of the second aspect, in a second possible implementation of the second aspect, the delivering, by the network device, configuration information includes: sending, by the network device, configuration information of a radio bearer separately to the first terminal and the second terminal, where the configuration information of the radio bearer is used to generate link configuration information, the link configuration information is used to establish the preset-protocol-based communication link between the first terminal and the second terminal, and the radio bearer is a radio bearer between the first terminal and the network device. Alternately, the determining comprises sending, by the network device, configuration information of a radio bearer to the second terminal, where the configuration information of the radio bearer is used to generate link configuration information, the link configuration information is used to establish the preset-protocol-based communication link between the first terminal and the second terminal, and the radio bearer is a radio bearer between the first terminal and the network device. Alternately, the determining comprises sending, by the network device, link configuration information separately to the first terminal and the second terminal, where the link configuration information is used to establish the preset-protocol-based communication link between the first terminal and the second terminal.

With reference to the second aspect, or the first or the second possible implementation of the second aspect, in a third possible implementation of the second aspect, the method further includes transmitting, by the network device, a packet with the first terminal by using the second terminal.

With reference to the third possible implementation of the second aspect, in a fourth possible implementation of the second aspect, the transmitting, by the network device, a packet to the first terminal by using the second terminal includes: receiving, by the network device through the cellular network communication link, a cellular network packet sent by the second terminal, where the cellular network packet is obtained by the second terminal by converting a preset-protocol-based packet, and the preset-protocol-based packet is sent by the first terminal to the second terminal through the preset-protocol-based communication link. Alternatively, the transmitting may comprise sending, by the network device, a cellular network packet to the second terminal through the cellular network communication link, so that the second terminal converts the received cellular network packet into a preset-protocol-based packet, and sends the preset-protocol-based packet to the first terminal through the preset-protocol-based communication link.

According to a third aspect, an embodiment of the present application provides a communication link establishment method. The method includes determining, by a second terminal, that a first terminal establishes a connection to a network device, where a cellular network communication link has been established between the second terminal and the network device. The method further includes determining, by the second terminal, link configuration information, and establishing, based on the link configuration information, a preset-protocol-based communication link with the first terminal. The preset protocol is a Bluetooth protocol or a Wireless Fidelity WiFi protocol, and the preset-protocol-based communication link and the cellular network communication link are jointly used by the first terminal and the second terminal to transmit a packet to the network device by using the second terminal. In a process in which the first terminal transmits a packet with the network device by using the second terminal, the first terminal and the second terminal both have a packet conversion function, and the packet conversion function is to convert the transmitted packet between a preset-protocol-based packet and a cellular network packet.

With reference to the third aspect, in a first possible implementation, the determining, by the second terminal, link configuration information includes: receiving, by the second terminal, the link configuration information sent by the network device.

With reference to the third aspect, in a second possible implementation, the determining, by the second terminal, link configuration information includes: receiving, by the second terminal, configuration information that is of a radio bearer and that is sent by the network device, and generating, by the second terminal, the link configuration information based on the configuration information of the radio bearer, where the radio bearer is a radio bearer between the first terminal and the network device.

With reference to the second possible implementation of the third aspect, in a third possible implementation of the third aspect, the method further includes: sending, by the second terminal, the link configuration information to the first terminal.

With reference to any one of the third aspect or the first to the third possible implementations of the third aspect, in a fourth possible implementation of the third aspect, after the establishing, by the second terminal, a preset-protocol-based communication link with the first terminal, the method further includes: in the process in which the first terminal transmits a packet with the network device by using the second terminal, receiving, by the second terminal through the preset-protocol-based communication link, a preset-protocol-based packet sent by the first terminal; and converting, by the second terminal, the preset-protocol-based packet into a cellular network packet, and sending the cellular network packet to the network device through the cellular network communication link.

With reference to any one of the third aspect or the first to the fourth possible implementations of the third aspect, in a fifth possible implementation of the third aspect, after the establishing, by the second terminal, a preset-protocol-based communication link with the first terminal, the method further includes: in the process in which the first terminal transmits a packet with the network device by using the second terminal, receiving, by the second terminal through the cellular network communication link, a cellular network packet sent by the network device; and converting, by the second terminal, the cellular network packet into a preset-protocol-based packet, and sending the preset-protocol-based packet to the first terminal through the preset-protocol-based communication link.

According to a fourth aspect, an embodiment of the present application provides a network connection determining method, including: obtaining, by a first terminal, an identifier of a network connected to a second terminal; and when the identifier of the network connected to the second terminal is consistent with an identifier of a network to which the first terminal subscribes, determining, by the first terminal, that the first terminal can establish a connection to the network device by using the second terminal, where the network device is a device in the network connected to the second terminal.

With reference to the fourth aspect, in a first possible implementation, the obtaining, by a first terminal, an identifier of a network connected to a second terminal includes: receiving, by the first terminal, first information broadcast by the second terminal, where the first information includes the identifier of the network connected to the second terminal, and a packet format of the first information is based on a Bluetooth protocol or a Wireless Fidelity WiFi protocol; converting, by the first terminal, the first information into second information, where a packet format of the second information is based on a cellular network protocol; and obtaining, by the first terminal by parsing the second information, the identifier of the network connected to the second terminal.

With reference to the fourth aspect or the first possible implementation of the fourth aspect, in a second possible implementation of the fourth aspect, after the determining, by the first terminal, that the first terminal can establish a connection to the network device by using the second terminal, the method further includes: sending, by the first terminal, a request message to the network device by using the second terminal, where the request message is used by the first terminal to request to establish a connection to the network device.

According to a fifth aspect, an embodiment of the present application provides a network connection determining method. The method includes determining, by a second terminal, first information, where the first information includes an identifier of a network connected to the second terminal, the identifier of the network connected to the second terminal is used by a first terminal to determine that the first terminal can establish a connection to a network device by using the second terminal, and the network device is a device in the network connected to the second terminal; and broadcasting, by the second terminal, the first information.

With reference to the fifth aspect, in a first possible implementation, the determining, by a second terminal, first information includes receiving, by the second terminal, third information sent by the network device, where the third information includes the identifier of the network connected to the second terminal, and a packet format of the third information is based on a cellular network protocol. The determining further includes converting, by the second terminal, the third information into the first information, where a packet format of the first information is based on a Bluetooth protocol or a Wireless Fidelity WiFi protocol.

With reference to the fifth aspect or the first possible implementation of the fifth aspect, in a second possible implementation of the fifth aspect, after the broadcasting, by the second terminal, the first information, the method further includes: forwarding, by the second terminal to the network device, a request message sent by the first terminal, where the request message is used by the first terminal to request to establish a connection to the network device.

According to a sixth aspect, an embodiment of the present application provides a protocol stack, where the protocol stack is applied to a system in which a first terminal connects to a network device by using a second terminal, and the protocol stack includes a first terminal protocol stack, a second terminal protocol stack, and a network device protocol stack; the first terminal protocol stack includes a cellular network Packet Data Convergence Protocol PDCP layer, an adaptation layer, and a preset protocol stack that are successively arranged from an upper layer to a bottom layer, where the preset protocol stack is based on a Bluetooth protocol or a Wireless Fidelity WiFi protocol; the second terminal protocol stack includes a protocol stack on a first interface side between the second terminal and the first terminal and a protocol stack on a second interface side between the second terminal and the network device; where the protocol stack on the first interface side includes an adaptation layer and a preset protocol stack that are successively arranged from an upper layer to a bottom layer and that are peering to the first terminal protocol stack; and the protocol stack on the second interface side includes a second Radio Link Control RLC layer, a second Media Access Control MAC layer, and a second physical PHY layer that are successively arranged from an upper layer to a bottom layer; the network device protocol stack includes a cellular network PDCP layer that is peering to the first terminal protocol stack and a second RLC layer, a second MAC layer, and a second PHY layer that are peering to the protocol stack on the second interface side, where the cellular network PDCP layer, the second RLC layer, the second MAC layer, and the second PHY layer are successively arranged from an upper layer to a bottom layer; and in response to determining that the protocol stack includes a control plane protocol stack, a cellular network radio resource control RRC layer is arranged above the cellular network PDCP layer of the first terminal protocol stack, and a cellular network RRC layer that is peering to the first terminal protocol stack is arranged above the cellular network PDCP layer of the network device protocol stack.

According to the sixth aspect, in a first possible implementation, the first terminal transmits a packet with the second terminal through a preset-protocol-based communication link, where the preset protocol is a Bluetooth protocol or a WiFi protocol; a cellular network RLC layer is arranged between the cellular network PDCP layer and the adaptation layer in the first terminal protocol stack; and a cellular network RLC layer that is peering to the first terminal protocol stack is arranged below the cellular network PDCP layer in the network side protocol stack.

With reference to the sixth aspect, in a second possible implementation, the adaptation layer is configured to: implement a function of converting a packet between a preset-protocol-based packet and a cellular network packet; and implement a function of configuring parameter information of the preset protocol stack.

With reference to the sixth aspect, in a third possible implementation, the second terminal transmits a packet with the network device through a cellular network communication link; a second PDCP layer is arranged above the second RLC layer of the second terminal protocol stack; a second PDCP layer that is peering to the second terminal protocol stack is arranged between the cellular network PDCP layer and the second RLC layer of the network device protocol stack; and the second PDCP layer is configured to implement a function of packet security processing negotiated between the second terminal and the network device.

With reference to the third possible implementation of the sixth aspect, in a fourth possible implementation of the sixth aspect, the adaptation layer in the protocol stack on the first interface side is configured to implement a function of transmitting a packet with the second PDCP layer or the second RLC layer in the protocol stack on the second interface side.

With reference to the sixth aspect or the second possible implementation of the sixth aspect, in a fifth possible implementation of the sixth aspect, the preset protocol stack is based on a Bluetooth protocol, and the preset protocol stack has a Logical Link Control and Adaptation Protocol L2CAP layer and a first PHY layer that are successively arranged from an upper layer to a bottom layer; or the preset protocol stack is based on a WiFi protocol, and the preset protocol stack has a first MAC layer and a first PHY layer that are successively arranged from an upper layer to a bottom layer.

According to a seventh aspect, an embodiment of the present application provides a first terminal, including: a network connection unit, configured to establish a connection between the first terminal and a network device by using a second terminal, where a cellular network communication link has been established between the second terminal and the network device; a link establishment unit, configured to, after the network connection unit establishes a connection between the first terminal and the network device by using the second terminal, determine link configuration information, and establish, based on the link configuration information, a preset-protocol-based communication link between the first terminal and the second terminal; where the preset protocol is a Bluetooth protocol or a Wireless Fidelity WiFi protocol, and the preset-protocol-based communication link and the cellular network communication link are jointly used by the first terminal to transmit a packet with the network device by using the second terminal; and a protocol adaptation unit, configured to, after the link establishment unit establishes the preset-protocol-based communication link between the first terminal and the second terminal, in a process in which the first terminal transmits a packet with the network device by using the second terminal, convert the transmitted packet between a preset-protocol-based packet and a cellular network packet, and transfer the packet inside the first terminal.

With reference to the seventh aspect, in a first possible implementation, when determining the link configuration information, the link establishment unit is specifically configured to: receive configuration information that is of a radio bearer and that is sent by the network device, and generate the link configuration information based on the configuration information of the radio bearer, where the radio bearer is a radio bearer between the first terminal and the network device; or receive the link configuration information sent by the network device; or receive the link configuration information sent by the second terminal; or generate the link configuration information based on preconfigured information.

With reference to the seventh aspect or the first possible implementation of the seventh aspect, in a second possible implementation of the seventh aspect, the first terminal further includes: a packet transmission unit, configured to transmit a packet with the network device by using the second terminal.

With reference to the second possible implementation of the seventh aspect, in a third possible implementation of the seventh aspect, the packet transmission unit is specifically configured to: convert a cellular network packet generated by a cellular network module into a preset-protocol-based packet; and send the preset-protocol-based packet to the second terminal through the preset-protocol-based communication link, so that after converting the received preset-protocol-based packet into the cellular network packet, the second terminal sends the cellular network packet to the network device through the cellular network communication link.

With reference to the second or the third possible implementation of the seventh aspect, in a fourth possible implementation of the seventh aspect, the packet transmission unit is specifically configured to: receive a preset-protocol-based packet of the second terminal through the preset-protocol-based communication link, where the preset-protocol-based packet is obtained by the second terminal by converting a cellular network packet, and the cellular network packet is sent by the network device to the second terminal through the cellular network communication link; and convert the preset-protocol-based packet into the cellular network packet, and transfer the cellular network packet to the cellular network module for processing.

According to an eighth aspect, an embodiment of the present application provides a network device, including: a network connection unit, configured to establish a connection between the network device and a first terminal by using a second terminal, where a cellular network communication link has been established between the second terminal and the network device; and a configuration information delivering unit, configured to deliver configuration information after the network connection unit establishes a connection between the network device and the first terminal by using the second terminal, where the configuration information is used to establish a preset-protocol-based communication link between the first terminal and the second terminal; where the preset protocol is a Bluetooth protocol or a Wireless Fidelity WiFi protocol, and the preset-protocol-based communication link and the cellular network communication link are jointly used by the first terminal to transmit a packet with the network device by using the second terminal; and in a process in which the first terminal transmits a packet with the network device by using the second terminal, the first terminal and the second terminal both have a packet conversion function, and the packet conversion function is to convert the transmitted packet between a preset-protocol-based packet and a cellular network packet.

With reference to the eighth aspect, in a first possible implementation, the network connection unit is specifically configured to: receive, by using the second terminal, a request message sent by the first terminal, where the request message is used by the first terminal to request to establish a connection to the network device.

With reference to the eighth aspect or the first possible implementation of the eighth aspect, in a second possible implementation of the eighth aspect, the configuration information delivering unit is specifically configured to: send configuration information of a radio bearer separately to the first terminal and the second terminal, where the configuration information of the radio bearer is used to generate link configuration information, the link configuration information is used to establish the preset-protocol-based communication link between the first terminal and the second terminal, and the radio bearer is a radio bearer between the first terminal and the network device; or send configuration information of a radio bearer to the second terminal, where the configuration information of the radio bearer is used to generate link configuration information, the link configuration information is used to establish the preset-protocol-based communication link between the first terminal and the second terminal, and the radio bearer is a radio bearer between the first terminal and the network device; or send link configuration information separately to the first terminal and the second terminal, where the link configuration information is used to establish the preset-protocol-based communication link between the first terminal and the second terminal.

With reference to the eighth aspect or the first or the second possible implementation of the eighth aspect, in a third possible implementation of the eighth aspect, the network device further includes: a packet transmission unit, configured to transmit a packet with the first terminal by using the second terminal.

With reference to the third possible implementation of the eighth aspect, in a fourth possible implementation of the eighth aspect, the packet transmission unit is specifically configured to: receive, through the cellular network communication link, a cellular network packet sent by the second terminal, where the cellular network packet is obtained by the second terminal by converting a preset-protocol-based packet, and the preset-protocol-based packet is sent by the first terminal to the second terminal through the preset-protocol-based communication link; and/or send a cellular network packet to the second terminal through the cellular network communication link, so that the second terminal converts the received cellular network packet into a preset-protocol-based packet, and sends the preset-protocol-based packet to the first terminal through the preset-protocol-based communication link.

According to a ninth aspect, an embodiment of the present application provides a second terminal, including: a network connection determining unit, configured to determine that a first terminal establishes a connection to a network device, where a cellular network communication link has been established between the second terminal and the network device; a link establishment unit, configured to, after the network connection determining unit determines that the first terminal establishes a connection to the network device, determine link configuration information, and establish, based on the link configuration information, a preset-protocol-based communication link between the second terminal and the first terminal; where the preset protocol is a Bluetooth protocol or a Wireless Fidelity WiFi protocol, and the preset-protocol-based communication link and the cellular network communication link are jointly used by the first terminal to transmit a packet with the network device by using the second terminal; and a protocol adaptation unit, configured to, after the link establishment unit establishes the preset-protocol-based communication link between the second terminal and the first terminal, in a process in which the first terminal transmits a packet with the network device by using the second terminal, convert the transmitted packet between a preset-protocol-based packet and a cellular network packet, and transfer the packet inside the second terminal.

With reference to the ninth aspect, in a first possible implementation, when determining the link configuration information, the link establishment unit is specifically configured to: receive the link configuration information sent by the network device.

With reference to the ninth aspect, in a second possible implementation, when determining the link configuration information, the link establishment unit is specifically configured to: receive configuration information that is of a radio bearer and that is sent by the network device, and generate the link configuration information based on the configuration information of the radio bearer, where the radio bearer is a radio bearer between the first terminal and the network device.

With reference to the second possible implementation of the ninth aspect, in a third possible implementation of the ninth aspect, the link establishment unit is further configured to: send the link configuration information to the first terminal.

With reference to any one of the ninth aspect or the first to the third possible implementations of the ninth aspect, in a fourth possible implementation of the ninth aspect, the second terminal further includes: a first packet transmission unit, configured to, in the process in which the first terminal transmits a packet with the network device by using the second terminal, receive, through the preset-protocol-based communication link, a preset-protocol-based packet sent by the first terminal; and convert the preset-protocol-based packet into a cellular network packet, and send the cellular network packet to the network device through the cellular network communication link.

With reference to any one of the ninth aspect or the first to the fourth possible implementations of the ninth aspect, in a fifth possible implementation of the ninth aspect, the second terminal further includes: a second packet transmission unit, configured to, in the process in which the first terminal transmits a packet with the network device by using the second terminal, receive, through the cellular network communication link, a cellular network packet sent by the network device; and convert the cellular network packet into a preset-protocol-based packet, and send the preset-protocol-based packet to the first terminal through the preset-protocol-based communication link.

According to a tenth aspect, an embodiment of the present application provides a network connection determining apparatus, applied to a first terminal, and including: a network identifier obtaining unit, configured to obtain an identifier of a network connected to a second terminal; and a network connection determining unit, configured to, when the identifier that is obtained by the network identifier obtaining unit and that is of the network connected to the second terminal is consistent with an identifier of a network to which the first terminal subscribes, determine that the first terminal can establish a connection to a network device by using the second terminal, where the network device is a device in the network connected to the second terminal.

With reference to the tenth aspect, in a first possible implementation, the network identifier obtaining unit is specifically configured to: receive first information broadcast by the second terminal, where the first information includes the identifier of the network connected to the second terminal, and a packet format of the first information is based on a Bluetooth protocol or a Wireless Fidelity WiFi protocol; convert the first information into second information, where a packet format of the second information is based on a cellular network protocol; and obtain, by parsing the second information, the identifier of the network connected to the second terminal.

With reference to the tenth aspect or the first possible implementation of the tenth aspect, in a second possible implementation of the tenth aspect, the apparatus further includes: a network connection establishment unit, configured to send a request message to the network device by using the second terminal, where the request message is used by the first terminal to request to establish a connection to the network device.

According to an eleventh aspect, an embodiment of the present application provides a network connection determining apparatus, applied to a second terminal, and including: an information determining unit, configured to determine first information, where the first information includes an identifier of a network connected to the second terminal, the identifier of the network connected to the second terminal is used by a first terminal to determine that the first terminal can establish a connection to a network device by using the second terminal, and the network device is a device in the network connected to the second terminal; and an information sending unit, configured to broadcast the first information determined by the information determining unit.

With reference to the eleventh aspect, in a first possible implementation, the information determining unit is specifically configured to: receive third information sent by the network device, where the third information includes the identifier of the network connected to the second terminal, and a packet format of the third information is based on a cellular network protocol; and convert the third information into the first information, where a packet format of the first information is based on a Bluetooth protocol or a Wireless Fidelity WiFi protocol.

With reference to the eleventh aspect or the first possible implementation of the fifth aspect, the apparatus further includes: a network connection establishment unit, configured to forward, to the network device, a request message sent by the first terminal, where the request message is used by the first terminal to request to establish a connection to the network device.

The embodiments of the present application provide the protocol stack and the communication link establishment method, to establish a security connection between the first terminal and the network device, so that the network device can directly manage the first terminal, for example, the network device can provide a value-added service for the first terminal. A Bluetooth-protocol-based or WiFi-protocol-based communication link between the first terminal and the second terminal can avoid a prior-art process of generating a new packet during packet forwarding by the second terminal, thereby reducing a security risk in a packet transmission process.

For a core network, the protocol stack provided in the embodiments of the present application is equivalent to that the first terminal directly connects to a base station in the network device by using a Uu interface. This can maintain compatibility of the core network. In addition, the network device directly manages the first terminal, and the network device stores information such as a context of the first terminal. Even if a connection between the first terminal and the second terminal is interrupted due to a factor such as a long distance from the second terminal serving as a relay device to the first terminal, the network device can quickly recover a service data transmission capability, thereby reducing complexity of a mobility processing flow, and further reducing a delay.

### BRIEF DESCRIPTION OF THE DRAWINGS

FIG. 1a is a schematic structural diagram of a user plane protocol stack according to an embodiment of the present application;

FIG. 1b is a schematic structural diagram of a control plane protocol stack according to an embodiment of the present application;

FIG. 2a is a schematic structural diagram of an adaptation layer in a first terminal protocol stack according to an embodiment of the present application;

FIG. 2b is a schematic structural diagram of an adaptation layer in a second terminal protocol stack according to an embodiment of the present application;

FIG. 3 is a schematic flowchart of a communication link establishment method according to an embodiment of the present application;

FIG. 4 is a schematic flowchart of a network connection determining method according to an embodiment of the present application;

FIG. 5 is a schematic flowchart of a communication link establishment method according to an embodiment of the present application;

FIG. 6 is a schematic flowchart of a communication link establishment method according to an embodiment of the present application;

FIG. 7 is a schematic flowchart of a communication link establishment method according to an embodiment of the present application;

FIG. 8 is a schematic structural diagram of a first terminal according to an embodiment of the present application;

FIG. 9 is a schematic structural diagram of a network device according to an embodiment of the present application;

FIG. 10 is a schematic structural diagram of a second terminal according to an embodiment of the present application;

FIG. 11 is a schematic structural diagram of a network connection determining apparatus according to an embodiment of the present application;

FIG. 12 is a schematic structural diagram of a network connection determining apparatus according to an embodiment of the present application;

FIG. 13 is a schematic structural diagram of a first terminal according to an embodiment of the present application;

FIG. 14 is a schematic structural diagram of a network device according to an embodiment of the present application; and

FIG. 15 is a schematic structural diagram of a second terminal according to an embodiment of the present application.

### DETAILED DESCRIPTION OF ILLUSTRATIVE EMBODIMENTS

The following clearly and completely describes the technical solutions in the embodiments of the present application with reference to the accompanying drawings in the embodiments of the present application. Apparently, the described embodiments are merely some but not all of the embodiments of the present application. For example, other embodiments obtained, by a person of ordinary skill in the art, based on the embodiments of the present application fall within the protection scope of the present application.

The embodiments of the present application provide a communication link establishment method, a protocol stack, a terminal, and a network device, to establish a communication link between wearable equipment and a network device, so that the network device can directly manage the wearable equipment, and a security risk is reduced in a process in which the wearable equipment communicates with the network device by using a relay device. The method and the apparatus are conceived based on a same application. The method and the apparatus have similar principles for resolving the problems. Therefore, for implementation of the apparatus and the method, reference may be made to each other, and details of repeated parts are not described.

Embodiments of the present application may be applicable to a Long Term Evolution (LTE) system. In the described embodiments of the present application, a security communication link is established between a first terminal and a network device, the first terminal communicates with the network device by using a second terminal, and the network device can directly manage the first terminal.

The first terminal includes wearable equipment, also referred to as remote equipment. The wearable equipment includes smart glasses, a smart band, a smartwatch, smart shoes, and the like. The second terminal includes a relay device, for example, an intelligent mobile terminal such as a mobile phone. The network device includes a device in a cellular network connected to the second terminal. Specifically, the network device may be a base station. The first terminal establishes a connection to the network device by using the second terminal. The first terminal connects to the second terminal through a communication link that is based on a Bluetooth Low Energy (BLE) protocol or a Wireless Fidelity (WiFi) protocol. The second terminal connects to the network device in the cellular network.

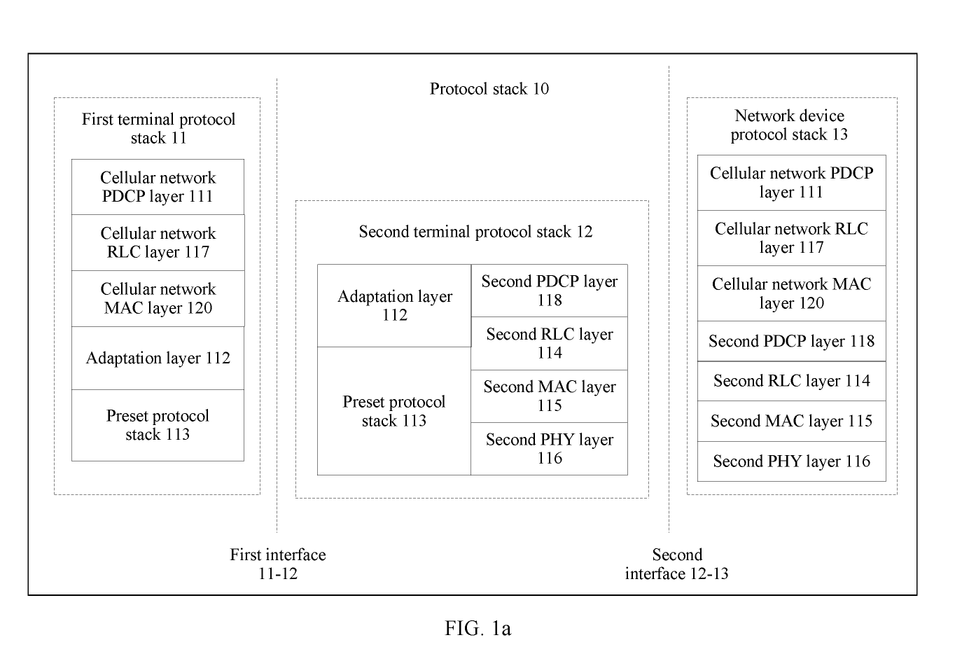

The technical solutions provided in the embodiments of the present application are based on protocol stacks shown in FIG. 1a and FIG. 1b. FIG. 1a shows a user plane protocol stack, and FIG. 1b shows a control plane protocol stack. Protocol stacks 10 shown in FIG. 1a and FIG. 1b are applied to a system in which a first terminal connects to a network device by using a second terminal.

A user plane protocol stack 10 in FIG. 1a includes a first terminal protocol stack 11, a second terminal protocol stack 12, and a network device protocol stack 13.

The first terminal protocol stack 11 includes a cellular network Packet Data Convergence Protocol (PDCP) layer 111, an adaptation layer 112, and a preset protocol stack 113 that are successively arranged from an upper layer to a bottom layer. The preset protocol stack 113 is based on a Bluetooth protocol or a WiFi protocol. The adaptation layer 112 is configured to implement a function of converting a packet between a preset-protocol-based packet and a cellular network packet and a function of configuring parameter information of the preset protocol stack 113.

If the first terminal transmits a packet with the second terminal through a Bluetooth-protocol-based communication link, the preset protocol stack 113 is based on the Bluetooth protocol, and the preset protocol stack 113 has a Logical Link Control and Adaptation Protocol (L2CAP) layer and a first PHY layer that are successively arranged from an upper layer to a bottom layer.

If the first terminal transmits a packet with the second terminal through a WiFi-protocol-based communication link, the preset protocol stack 113 is based on the WiFi protocol, and the preset protocol stack 113 has a first MAC layer and a first PHY layer that are successively arranged from an upper layer to a bottom layer.

The second terminal protocol stack 12 includes a protocol stack on a first interface 11-12 side between the second terminal and the first terminal, and a protocol stack on a second interface 12-13 side between the second terminal and the network device. A first interface 11-12 is an E-PC5-Bluetooth interface or an E-PC5-WiFi interface, and a second interface 12-13 is a Uu interface.

The protocol stack on the first interface 11-12 side includes an adaptation layer 112 and a preset protocol stack 113 that are successively arranged from an upper layer to a bottom layer and that are peering to the first terminal protocol stack 11.

The adaptation layer 112 in the protocol stack on the first interface 11-12 side is configured to implement a function of converting a packet between a preset-protocol-based packet and a cellular network packet and a function of configuring parameter information of the preset protocol stack 113.

The protocol stack on the second interface 12-13 side includes a second Radio Link Control (RLC) layer 114, a second Media Access Control (MAC) layer 115, and a second physical (PHY) layer 116 that are successively arranged from an upper layer to a bottom layer. The adaptation layer 112 in the protocol stack on the first interface 11-12 side is further configured to implement a function of transmitting a packet with the second RLC layer 114 in the protocol stack on the second interface 12-13 side.

The network device protocol stack 13 includes a cellular network PDCP layer in that is peering to the first terminal protocol stack 11 and a second RLC layer 114, a second MAC layer 115, and a second PHY layer 116 that are peering to the protocol stack on the second interface 12-13 side, where the cellular network PDCP layer in, the second RLC layer 114, the second MAC layer 115, and the second PHY layer 116 are successively arranged from an upper layer to a bottom layer. The cellular network PDCP layer 111 is configured to implement a function of packet security processing negotiated between the first terminal and the network device. The second terminal transmits a packet with the network device through a cellular network communication link.

Optionally, a cellular network RLC layer 117 is arranged between the cellular network PDCP layer in and the adaptation layer 112 in the first terminal protocol stack 11.

A cellular network RLC layer 117 that is peering to the first terminal protocol stack 11 is arranged below the cellular network PDCP layer 111 in the network side protocol stack.

Optionally, a second PDCP layer 118 is arranged above the second RLC layer 114 of the second terminal protocol stack 12.

A second PDCP layer 118 that is peering to the second terminal protocol stack 12 is arranged between the cellular network PDCP layer 111 and the second RLC layer 114 of the network device protocol stack 13.

The second PDCP layer 118 is configured to implement a function of packet security processing negotiated between the second terminal and the network device.

Optionally, the adaptation layer 112 in the protocol stack on the first interface 11-12 side is further configured to implement a function of transmitting a packet with the second PDCP layer 118 in the protocol stack on the second interface 12-13 side.

Optionally, a cellular network MAC layer 120 is arranged below the cellular network PDCP layer 111 in the first protocol stack 11.

A cellular network MAC layer 120 that is peering to the first protocol stack 11 is arranged below the cellular network PDCP layer in of the network device protocol stack 13.

By using the user plane protocol stack shown in FIG. 1a, for uplink transmitted data, the first terminal performs security processing at the cellular network PDCP layer on a packet sent from a cellular network module, and sends the packet to the network device by using the second terminal; for downlink transmitted data, the network device performs security processing at the cellular network PDCP layer on a packet sent from a core network, and sends the packet to the first terminal by using the second terminal.

A control plane protocol stack 10 shown in FIG. 1b includes a first terminal protocol stack 11, a second terminal protocol stack 12, and a network device protocol stack 13. As shown in FIG. 1b, the control plane protocol stack 10 shown in FIG. 1b has the following content added on basis of the user plane protocol stack 10 shown in FIG. 1a.

A cellular network radio resource control (RRC) layer 119 is arranged above the cellular network PDCP layer in of the first terminal protocol stack 11. A cellular network RRC layer 119 that is peering to the first terminal protocol stack 11 is arranged above the cellular network PDCP layer in of the network device protocol stack 13.

The cellular network RRC layer 119 is configured to manage parameter settings used by the first terminal to connect to the network device, configure security parameters for transmitting a packet and signaling between the first terminal and the network device, and configure a bearer of the first terminal. The bearer of the first terminal includes a radio bearer from the first terminal to the network device and a bearer from the network device to the core network.

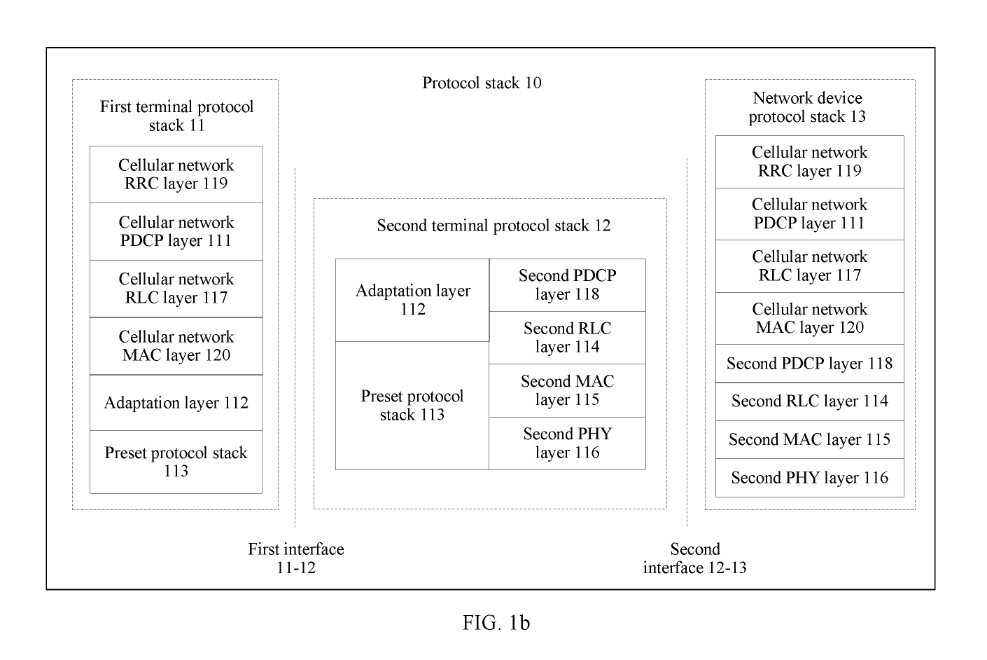

The adaptation layer 112 in the first terminal protocol stack is divided based on the functions implemented by the adaptation layer 112. As shown in FIG. 2a, the adaptation layer 112 includes a protocol packet conversion unit 1121 and a configuration unit 1122.

The protocol packet conversion unit 1121 is configured to implement a function of converting a packet between a Bluetooth protocol-based packet and a cellular network packet (namely, a cellular-network-protocol-based packet), or converting a packet between a WiFi-protocol-based packet and a cellular network packet. Specifically, based on the Bluetooth protocol or WiFi protocol, the protocol packet conversion unit 1121 performs byte order conversion on a packet and/or adds or deletes some header content of a packet. For uplink transmitted data, the protocol packet conversion unit 1121 converts a cellular network packet generated by the cellular network module into a Bluetooth-protocol-based or WiFi-protocol-based packet, so that the first terminal further sends the packet obtained through conversion to the second terminal. For downlink transmitted data, the protocol packet conversion unit 1121 converts a Bluetooth-protocol-based or WiFi-protocol-based packet from the second terminal into a cellular network packet, and transfers the packet to the cellular network module for further processing. A protocol layer of the cellular network module includes at least the cellular network RRC layer and/or the cellular network PDCP layer.

The configuration unit 1122 is configured to implement a function of configuring parameter information of the preset protocol stack 113, and may be further configured to implement a function of performing quality of service (QoS) class mapping on a packet of a radio bearer. The configuration unit 1122 is configured to configure, based on bearer configuration information of a cellular network, parameters of the protocol layers in the Bluetooth-protocol-based or WiFi-protocol-based preset protocol stack 113.

The radio bearer configuration information of the cellular network generally includes configuration parameters of the cellular network RLC layer and/or the cellular network MAC layer. These configuration parameters are used to ensure reliable transmitted data at a transmit end and a receive end of a protocol and to ensure a specific data transmission rate.

For example, a correspondence between the bearer configuration information of the cellular network and configuration information under the Bluetooth protocol is as follows:

When the cellular network RLC layer is configured in an acknowledge mode (AM), the L2CAP layer in the Bluetooth-protocol-based preset protocol stack should be configured in a mode with an acknowledgment from a receive end; when the cellular network MAC layer has a guaranteed bit rate (PBR) configured, a quantity of channels configured under the Bluetooth protocol should meet a value of the PBR.

The bearer configuration information of the cellular network includes a QoS class identifier (QCI). The QCI value is corresponding to a data transmission rate and a data transmission mode (including an acknowledged transmission mode, a retransmission mode, and an unacknowledged transmission mode) under the Bluetooth protocol. A quantity of channels at the L2CAP layer, a maximum packet value, a quantity of retransmission times, and the like are configured based on the QCI.

The adaptation layer 112 in the protocol stack on the first interface side of the second terminal protocol stack is divided based on the functions implemented by the adaptation layer 112. As shown in FIG. 2b, the adaptation layer 112 includes a protocol packet conversion unit 1121, a configuration unit 1122, and a packet forwarding unit 1123.

A difference between the adaptation layer 112 shown in FIG. 2b and the adaptation layer 112 shown in FIG. 2a lies in that: The packet forwarding unit 1123 is added to the adaptation layer 112 shown in FIG. 2b. The packet forwarding unit 1123 is configured to implement a function of transmitting a packet between the adaptation layer 112 and the second RLC layer or the second PDCP layer. For an uplink transmitted packet, the protocol packet conversion unit 1121 converts a Bluetooth-protocol-based or WiFi-protocol-based packet sent from the first terminal into a cellular network packet, and the packet forwarding unit 1123 transfers the cellular network packet to the second RLC layer or the second PDCP layer, so that the second terminal further sends the cellular network packet to the network device. For a downlink transmitted packet, the packet forwarding unit 1123 receives a cellular network packet from the second RLC layer or the second PDCP layer, and transfers the cellular network packet to the protocol packet conversion unit 1121, and the protocol packet conversion unit 1121 converts the cellular network packet into a Bluetooth-protocol-based or WiFi-protocol-based packet, so that the second terminal further sends the Bluetooth-protocol-based or WiFi-protocol-based packet to the first terminal.

It should be noted that, the adaptation layer in the protocol stack provided in the embodiments of the present application may be an independent entity, to implement a function of the adaptation layer. Alternatively, another existing protocol layer may be configured to implement the function of the adaptation layer. For example, the cellular network RRC layer is configured to implement a function of the configuration unit 1122 of the adaptation layer, and the cellular network PDCP layer is configured to implement functions of the protocol packet conversion unit 1121 and the packet forwarding unit 1123.

With the protocol stack provided in the embodiments of the present application, a security communication link can be established between the first terminal and the network device, so that the network device can directly manage the first terminal.

With reference to the protocol stack provided in the embodiments of the present application, the following describes in detail a communication link establishment method provided in an embodiment of the present application.

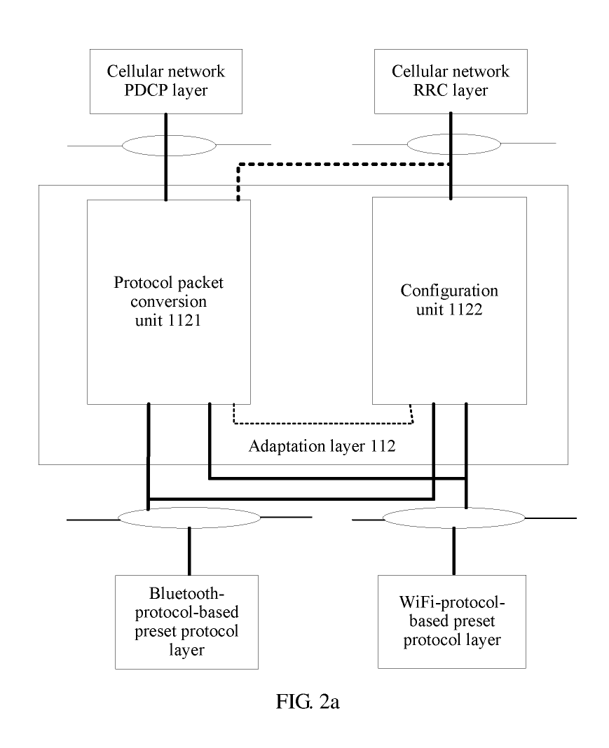

As shown in FIG. 3, an embodiment of the present application provides a communication link establishment method. The method is executed between a first terminal, a second terminal, and a network device. The method includes the following steps.

S301: The first terminal establishes a connection to the network device by using the second terminal. A cellular network communication link has been established between the second terminal and the network device.

S302: The network device delivers configuration information. The configuration information delivered by the network device is used to determine link configuration information of the first terminal and that of the second terminal. The link configuration information is used to establish a preset-protocol-based communication link between the first terminal and the second terminal. The preset protocol is a Bluetooth protocol or a WiFi protocol.

S303: The first terminal and the second terminal separately determine link configuration information, and establish a preset-protocol-based communication link between the first terminal and the second terminal based on the link configuration information. The preset-protocol-based communication link and the cellular network communication link are jointly used by the first terminal to transmit a packet with the network device by using the second terminal. In a process in which the first terminal transmits a packet with the network device by using the second terminal, the first terminal and the second terminal both have a packet conversion function, and the packet conversion function is to convert the transmitted packet between a preset-protocol-based packet and a cellular network packet.

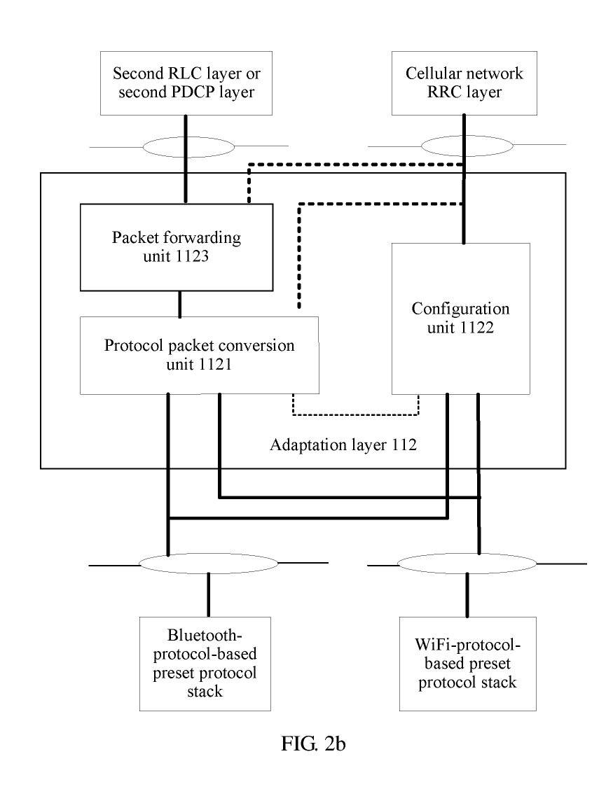

In S301 in this embodiment of the present application, the first terminal establishes a connection to the network device by using the second terminal. An embodiment of the present application further provides a network connection determining method. As shown in FIG. 4, an interaction process between the first terminal, the second terminal, and the network device is as follows.

S401: The second terminal determines first information, where the first information includes an identifier of a network connected to the second terminal. The identifier of the network connected to the second terminal is used by the first terminal to determine whether the first terminal can establish a connection to the network device by using the second terminal. The network device is a device in the network connected to the second terminal.

Optionally, the first information includes at least one or a combination of the following: a public land mobile network (PLMN) identifier, a cell identifier (cell ID), a device identifier, and an Internet Protocol (IP) address of a base station.

The PLMN identifier is an identifier of a cellular network connected to the second terminal, for example, China Mobile. The cell identifier is an identifier of a cell on which the second terminal currently camps or an identifier of a cell serving the second terminal. The device identifier is an identifier allocated to the second terminal by a network device (a base station or a core network device) in the cellular network connected to the second terminal. This identifier is used to indicate that the second terminal may be used as a relay device. The IP address of a base station is an IP address of a base station in the cellular network connected to the second terminal.

The second terminal determines the first information by receiving third information sent by the network device. The third information includes at least the identifier of the network connected to the second terminal. A packet format of the third information is based on a cellular network protocol. The third information may include some or all information included in the first information. The second terminal converts the third information sent from the network device into the first information by using an adaptation layer. A packet format of the first information is based on the Bluetooth protocol or the WiFi protocol.

Optionally, the second terminal obtains the third information by receiving an RRC message broadcast by the network device. The RRC message broadcast by the network device includes the third information.

S402: The second terminal broadcasts the first information.

If the second terminal broadcasts the first information through a Bluetooth broadcast channel, after obtaining Bluetooth-protocol-based first information through conversion, the adaptation layer of a second terminal protocol stack transfers the first information to an L2CAP layer in a Bluetooth-protocol-based preset protocol stack, and instructs to send the first information through a Bluetooth broadcast channel.

Optionally, the L2CAP layer in the Bluetooth-protocol-based preset protocol stack periodically sends the first information. By default, a period of the Bluetooth-protocol-based preset protocol stack may be defined to periodically send the first information, or the adaptation layer may be used to instruct the L2CAP layer in the Bluetooth-protocol-based preset protocol stack to periodically send the first information.

If the second terminal broadcasts the first information through a WiFi broadcast channel, after obtaining WiFi-protocol-based first information through conversion, the adaptation layer of the second terminal protocol stack transfers the first information to a first MAC layer in a WiFi-protocol-based preset protocol stack, and instructs the first MAC layer to use a traffic indication map (TIM) field in a beacon (Beacon) frame to send the first information.

All bits in an association identifier (Association ID) in the TIM field are set to 1. Content sent in the TIM field is referred to as a frame buffered by a base station. The frame buffered by the base station is periodically sent. A receive end of the frame buffered by the base station is a WiFi receive end corresponding to an association ID that has all its bits set to 1, to be specific, the first terminal in this embodiment of the present application. Setting all bits in the association ID to 1 indicates that all first terminals inside a range covered by WiFi signals of the second terminal serving a relay device can receive the first information sent over the TIM field.

S403: After receiving the first information broadcast by the second terminal, the first terminal determines, based on the identifier that is of the network connected to the second terminal and that is included in the first information, whether the first terminal can establish a connection to the network device by using the second terminal.

A cellular network RRC layer of the first terminal initiates a network searching mode based on a bottom layer protocol (including the Bluetooth protocol or the WiFi protocol) of a module of the first terminal, so that the first information broadcast by the second terminal is received through a Bluetooth-protocol-based broadcast channel or a WiFi-protocol-based broadcast channel. There are two network searching modes: One is to search for a relay device used by the first terminal to connect to the network device, namely, the second terminal; the other is to search for broadcast information of the cellular network. In consideration of a low power consumption characteristic of the first terminal and a fact that a relay device usually exists around the first terminal, the first terminal first searches for the relay device used by the first terminal to connect to the network device. If the first terminal fails to find an available relay device after a period of time, the first terminal searches for the broadcast information of the cellular network.

The cellular network RRC layer of the first terminal initiates the network searching mode, to instruct the Bluetooth-protocol-based or WiFi-protocol-based preset protocol stack to receive the first information broadcast by the second terminal. The packet format of the first information is based on the Bluetooth protocol or the Wireless Fidelity WiFi protocol. The first terminal converts the first information into second information by using an adaptation layer. A packet format of the second information is based on the cellular network protocol. The adaptation layer transfers the second information to the cellular network RRC layer to obtain, through parsing, the identifier of the network connected to the second terminal.

When the identifier of the network connected to the second terminal is consistent with an identifier of a network to which the first terminal subscribes, the first terminal determines that the first terminal can establish a connection to the network device by using the second terminal. The network device is a device in the network connected to the second terminal.

When the identifier of the network connected to the second terminal is inconsistent with the identifier of the network to which the first terminal subscribes, the first terminal determines that the first terminal cannot establish a connection to the network device by using the second terminal.

Optionally, after the first terminal determines that the first terminal can establish a connection to the network device by using the second terminal, the first terminal sends a request message to the network device by using the second terminal. The request message is used by the first terminal to request to establish or maintain a connection to the network device.

For S302 and S303 in this embodiment of the present application, S302 includes the configuration information delivered by the network device; S303 includes the link configuration information determined by the first terminal and that determined by the second terminal. The following four methods may be used to establish the preset-protocol-based communication link between the first terminal and the second terminal based on the link configuration information.

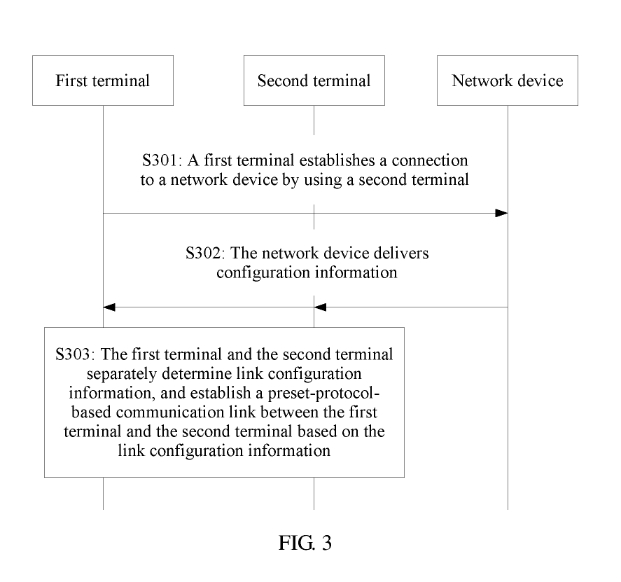

Method 1: As shown in FIG. 5, an interaction process between the first terminal, the second terminal, and the network device is as follows.

S501: The network device separately sends configuration information of a radio bearer to the first terminal and the second terminal. The radio bearer is a radio bearer between the first terminal and the network device.

S502: The first terminal generates the link configuration information based on the configuration information of the radio bearer.

S503: The second terminal generates the link configuration information based on the configuration information of the radio bearer.

It should be noted that, an execution sequence of S502 and S503 is not limited in this embodiment of the present application.

S504: The first terminal and the second terminal establish the preset-protocol-based communication link between the first terminal and the second terminal based on the link configuration information.

For establishment of a Bluetooth-protocol-based communication link between the first terminal and the second terminal, the adaptation layer establishes the Bluetooth-protocol-based communication link between the first terminal and the second terminal based on the configuration information of the radio bearer. Specifically, the adaptation layer maps a QoS parameter of the radio bearer to a QoS parameter of the Bluetooth protocol, and generates the link configuration information, including configuration parameters of a Bluetooth-protocol-based preset protocol stack, namely, a configuration parameter of an L2CAP layer and a configuration parameter of a first PHY layer. The adaptation layer sends the configuration parameter of the L2CAP layer and the configuration parameter of the first PHY layer to the Bluetooth-protocol-based preset protocol stack. In this way, based on the configuration parameter of the L2CAP layer and the configuration parameter of the first PHY layer, the Bluetooth-protocol-based preset protocol stack can set parameters of the L2CAP layer and a first PHY layer that are inside the Bluetooth-protocol-based preset protocol stack. After the first terminal and the second terminal both have their Bluetooth-protocol-based preset protocol stacks configured, the Bluetooth-protocol-based communication link can be established between the first terminal and the second terminal. Subsequently, the Bluetooth-protocol-based communication link and the cellular network communication link between the second terminal and the network device can be used, and the first terminal can transmit a packet with the network device by using the second terminal.

The adaptation layer establishes the Bluetooth-protocol-based communication link between the first terminal and the second terminal based on the configuration information of the radio bearer. In this way, a radio bearer between the first terminal and the network device can one-to-one correspond to a channel at the L2CAP layer, or all radio bearers between the first terminal and the network device can correspond to one channel at the L2CAP layer. A change made to the Bluetooth protocol in this embodiment is as follows: A protocol indication is added in Protocol/Service Multiplexer (PSM) to point to the adaptation layer. The adaptation layer of the second terminal further needs to configure a mapping and forwarding function between a channel at the L2CAP layer and a cellular module, including a mapping relationship between an identifier of a radio bearer and a channel identifier (CID), and a function of adding header information to and deleting header information from a packet to be forwarded by the second terminal, so that the second terminal can forward a packet of the first terminal to the network device.

For establishment of a WiFi-protocol-based communication link between the first terminal and the second terminal, the adaptation layer establishes the WiFi-protocol-based communication link between the first terminal and the second terminal based on the configuration information of the radio bearer. Specifically, the adaptation layer generates the link configuration information based on QoS parameters of the radio bearer, including configuration parameters of a Bluetooth-protocol-based preset protocol stack, namely, a configuration parameter of a first MAC layer and a configuration parameter of a first PHY layer. The adaptation layer sends the configuration parameter of the first MAC layer and the configuration parameter of the first PHY layer to the WiFi-protocol-based preset protocol stack. In this way, based on the configuration parameter of the first MAC layer and the configuration parameter of the first PHY layer, the WiFi-protocol-based preset protocol stack can set parameters of a first MAC layer and a first PHY layer that are inside the WiFi-protocol-based preset protocol stack. After the first terminal and the second terminal both have their WiFi-protocol-based preset protocol stacks configured, the WiFi-protocol-based communication link can be established between the first terminal and the second terminal. Subsequently, the WiFi-protocol-based communication link and the cellular network communication link between the second terminal and the network device can be used, and the first terminal can transmit a packet with the network device by using the second terminal.

A concept of traffic flow does not exist in a process of transmitting a packet through the WiFi-protocol-based communication link. Therefore, QoS classes of radio bearers instead of traffic flows need to be differentiated between the first terminal and the second terminal. The adaptation layer combines packets of radio bearers of a same QoS class to send to the first MAC layer. The adaptation layer is configured to implement a function of performing QoS class mapping on a packet of a radio bearer. For example, if a cellular network PDCP layer already adds an identifier of the first terminal and an identifier of a radio bearer to a packet of the radio bearer, the adaptation layer is configured to implement only a function of performing QoS class mapping on the packet of the radio bearer; or if the cellular network PDCP layer does not add the identifier of the first terminal and the identifier of the radio bearer to the packet of the radio bearer, the adaptation layer is configured to implement the function of performing QoS class mapping on the packet of the radio bearer, and is further configured to implement a function of adding the identifier of the first terminal and the identifier of the radio bearer to the packet of the radio bearer. The adaptation layer of the second terminal is further configured to implement a mapping and forwarding function between a cellular network module and the WiFi-protocol-based preset protocol stack.

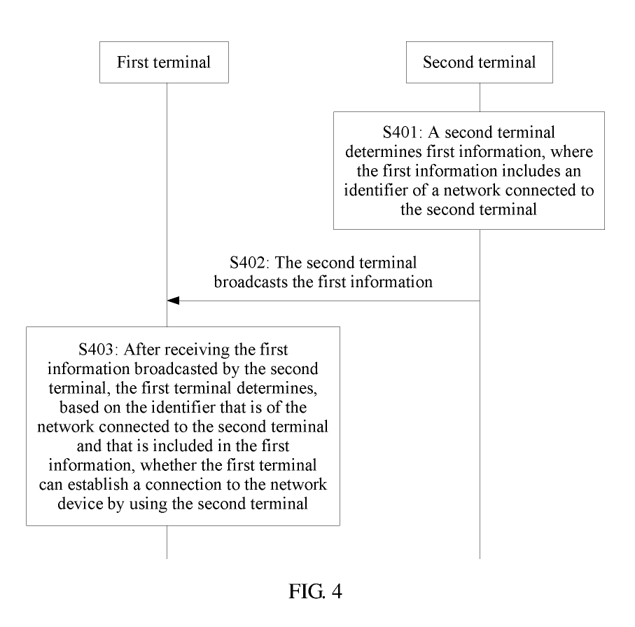

Method 2: As shown in FIG. 6, an interaction process between the first terminal, the second terminal, and the network device is as follows.

S601: The network device separately sends the link configuration information to the first terminal and the second terminal.

S602: The first terminal and the second terminal establish the preset-protocol-based communication link between the first terminal and the second terminal based on the link configuration information.

The method shown in FIG. 6 includes establishing a Bluetooth-protocol-based communication link between the first terminal and the second terminal or establishing a WiFi-protocol-based communication link between the first terminal and the second terminal. A difference between the communication link establishment method shown in FIG. 6 and that shown in FIG. 5 lies in the following.

For establishment of a Bluetooth-protocol-based communication link between the first terminal and the second terminal, the network device generates the link configuration information based on configuration information of a radio bearer. The link configuration information is used to establish the Bluetooth-protocol-based communication link between the first terminal and the second terminal. To be specific, the network device generates the link configuration information based on QoS parameters of the radio bearer, including configuration parameters of a Bluetooth-protocol-based preset protocol stack, namely, a configuration parameter of an L2CAP layer and a configuration parameter of a first PHY layer. The network device sends the configuration parameter of the L2CAP layer and the configuration parameter of the first PHY layer to the first terminal and the second terminal. In this way, based on the configuration parameter of the L2CAP layer and the configuration parameter of the first PHY layer, the Bluetooth-protocol-based preset protocol stack in each of the first terminal and the second terminal sets parameters of the L2CAP layer and a first PHY layer that are inside the Bluetooth-protocol-based preset protocol stack. After the first terminal and the second terminal both have their Bluetooth-protocol-based preset protocol stacks configured, the Bluetooth-protocol-based communication link can be established between the first terminal and the second terminal. Subsequently, the Bluetooth-protocol-based communication link and the cellular network communication link between the second terminal and the network device can be used, and the first terminal can transmit a packet with the network device by using the second terminal.

For establishment of a WiFi-protocol-based communication link between the first terminal and the second terminal, the network device generates the link configuration information based on configuration information of a radio bearer. The link configuration information is used to establish the WiFi-protocol-based communication link between the first terminal and the second terminal. To be specific, the network device generates the link configuration information based on QoS parameters of the radio bearer, including configuration parameters of a WiFi-protocol-based preset protocol stack, namely, a configuration parameter of a first MAC layer and a configuration parameter of a first PHY layer. The network device sends the configuration parameter of the first MAC layer and the configuration parameter of the first PHY layer to the WiFi-protocol-based preset protocol stack. In this way, based on the configuration parameter of the first MAC layer and the configuration parameter of the first PHY layer, the WiFi-protocol-based preset protocol stack in each of the first terminal and the second terminal sets parameters of a first MAC layer and a first PHY layer that are inside the WiFi-protocol-based preset protocol stack. After the first terminal and the second terminal both have their WiFi-protocol-based preset protocol stacks configured, the WiFi-protocol-based communication link can be established between the first terminal and the second terminal. Subsequently, the WiFi-protocol-based communication link and the cellular network communication link between the second terminal and the network device can be used, and the first terminal can transmit a packet with the network device by using the second terminal.

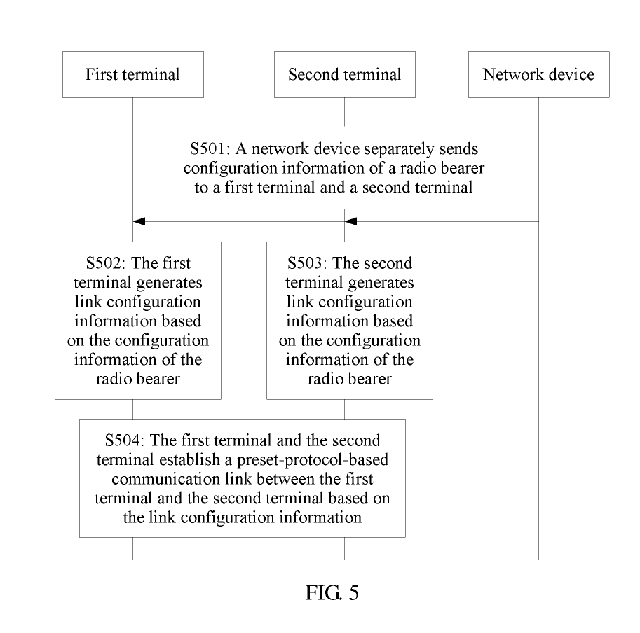

Method 3: As shown in FIG. 7, an interaction process between the first terminal, the second terminal, and the network device is as follows.

S701: The network device sends configuration information of a radio bearer to the second terminal. The radio bearer is a radio bearer between the first terminal and the network device.

S702: The second terminal generates the link configuration information based on the configuration information of the radio bearer.

S703: The second terminal sends the link configuration information to the first terminal.

S704: The first terminal and the second terminal establish the preset-protocol-based communication link between the first terminal and the second terminal based on the link configuration information.

The method shown in FIG. 7 includes establishing a Bluetooth-protocol-based communication link between the first terminal and the second terminal or establishing a WiFi-protocol-based communication link between the first terminal and second terminal. A difference between the communication link establishment method shown in FIG. 7 and those shown in FIG. 5 and FIG. 6 lies in the following:

The network device sends the configuration information of the radio bearer to the second terminal, so that the second terminal generates the link configuration information. The second terminal sends the link configuration information to the first terminal, and the first terminal and the second terminal further set their own preset protocol stacks based on the link configuration information, including the Bluetooth-protocol-based preset protocol stack or the WiFi-protocol-based preset protocol stack. After the first terminal and the second terminal both have their own WiFi-protocol-based preset protocol stacks configured, the preset-protocol-based communication link can be established between the first terminal and the second terminal. A specific process is similar to that in FIG. 5 or FIG. 6, and details are not described herein again.

Method 4: When the first terminal establishes a connection to the network device by using the second terminal, the first terminal and the second terminal learn, by receiving an RRC message broadcast by the network device, that a cellular network system of the network device is an LTE system, and generate preconfigured information. The adaptation layer generates the link configuration information based on the preconfigured information, and sends the link configuration information to the preset protocol stack, including the Bluetooth-protocol-based preset protocol stack or the WiFi-protocol-based preset protocol stack. The preset protocol stack sets parameters of protocol layers inside the preset protocol stack based on the link configuration information. After the first terminal and the second terminal both have their own WiFi-protocol-based preset protocol stacks configured, the preset-protocol-based communication link can be established between the first terminal and the second terminal. A specific process is similar to those in FIG. 5 to FIG. 7, and details are not described herein again.

The preconfigured information may include any least one or a combination of the following: initial bearer configuration information: including configuration information of the cellular network RCL layer and configuration information of the cellular network MAC layer, where the adaptation layer may generate the configuration parameters of the protocol layers in the preset protocol stack based on the initial bearer configuration information; initial link configuration information and configuration parameters of the L2CAP layer that are in the Bluetooth protocol: for example, a data transmission mode, a maximum packet length, and a quantity of channels at the first PHY layer; configuration parameters in the WiFi protocol: for example, a transmit power level and a length of a listening window; and transmission quality reference values in the cellular network, including a link rate, a maximum packet transmission delay, and the like, for example, transmission quality reference values listed in the following Table 1.

TABLE 1

| | | Maximum |
|---|---|---|
| | | packet |
| | | transmission |
| QCI | Data rate | delay |
| 0 | 20 kbps | 300 ms |
| 1 | 32 kbps | 200 ms |
| 2 | 64 kbps | 200 ms |
| 3 | 128 kbps | 200 ms |
| 4 | 512 kbps | 100 ms |
| 5 | 1024 kbps | 100 ms |
| 6 | 2048 kbps | 100 ms |
| 7 | 2048 kbps | 50 ms |

In this embodiment of the present application, the preset-protocol-based communication link (the communication link between the first terminal and the second terminal) and the cellular network communication link (the communication link between the second terminal and the network device) are jointly used by the first terminal to transmit a packet with the network device by using the second terminal. In a process in which the first terminal transmits a packet with the network device by using the second terminal, the first terminal and the second terminal both have a packet conversion function. The packet conversion function is to convert the transmitted packet between a preset-protocol-based packet and a cellular network packet.

With reference to the protocol stack provided in this embodiment of the present application, the following describes in detail the process in which the first terminal transmits a packet with the network device by using the second terminal. The process in which the first terminal transmits a packet with the network device by using the second terminal is as follows.

A process of transmitting an uplink packet includes the following. A cellular network packet generated by a cellular network module of the first terminal passes through the PDCP layer of the cellular network for security processing and then is transferred to the adaptation layer. The adaptation layer converts the cellular network packet into a preset-protocol-based packet. In correspondence to the Bluetooth-protocol-based communication link or the WiFi-protocol-based communication link between the first terminal and the second terminal, the preset-protocol-based packet includes a Bluetooth-protocol-based packet or a WiFi-protocol-based packet. The adaptation layer transfers the Bluetooth-protocol-based packet to the L2CAP layer of the Bluetooth-protocol-based preset protocol stack, and the L2CAP layer sends the Bluetooth-protocol-based packet to the L2CAP layer of the second terminal. Alternatively, the adaptation layer transfers the WiFi-protocol-based packet to the first MAC layer of the WiFi-protocol-based preset protocol stack, and the first MAC layer sends the WiFi-protocol-based packet to the first MAC layer of the second terminal.

After receiving the Bluetooth-protocol-based packet, the L2CAP layer of the second terminal transfers the Bluetooth-protocol-based packet to the adaptation layer; the adaptation layer converts the Bluetooth-protocol-based packet into a cellular network packet and transfers the cellular network packet to the second PDCP layer; the second PDCP layer sends the cellular network packet to the second PDCP layer of the network device by using a Uu interface between the second terminal and the network device; the network device performs further processing on the cellular network packet inside the network device. In this way, the first terminal sends an uplink packet to the network device by using the second terminal. Alternatively, after receiving the WiFi-protocol-based packet, the first MAC layer of the second terminal transfers the WiFi-protocol-based packet to the adaptation layer; the adaptation layer converts the WiFi-protocol-based packet into a cellular network packet and transfers the cellular network packet to the second PDCP layer; the second PDCP layer sends the cellular network packet to the second PDCP layer of the network device by using a Uu interface between the second terminal and the network device; the network device performs further processing on the cellular network packet inside the network device. In this way, the first terminal sends an uplink packet to the network device by using the second terminal.

A process of transmitting a downlink packet is inversed to the process of transmitting an uplink packet, and includes the following. A cellular network packet generated by a cellular network module of the network device passes through the cellular network PDCP layer for security processing and is transferred to the second PDCP layer, and the second PDCP layer sends the cellular network packet to the second PDCP layer of the second terminal by using a Uu interface between the second terminal and the network device.

After receiving the cellular network packet, the second PDCP layer of the second terminal transfers the cellular network packet to the adaptation layer, and the adaptation layer converts the cellular network packet into a preset-protocol-based packet. In correspondence to the Bluetooth-protocol-based communication link or the WiFi-protocol-based communication link between the first terminal and the second terminal, the preset-protocol-based packet includes a Bluetooth-protocol-based packet or a WiFi-protocol-based packet. The adaptation layer transfers the Bluetooth-protocol-based packet to the L2CAP layer of the Bluetooth-protocol-based preset protocol stack, and the L2CAP layer sends the Bluetooth-protocol-based packet to the L2CAP layer of the first terminal. Alternatively, the adaptation layer transfers the WiFi-protocol-based packet to the first MAC layer of the WiFi-protocol-based preset protocol stack, and the first MAC layer sends the WiFi-protocol-based packet to the first MAC layer of the first terminal.

After receiving the Bluetooth-protocol-based packet, the L2CAP layer of the first terminal transfers the Bluetooth-protocol-based packet to the adaptation layer; the adaptation layer converts the Bluetooth-protocol-based packet into the cellular network packet; the first terminal performs further processing on the cellular network packet inside the first terminal. In this way, the network device sends a downlink packet to the first terminal by using the second terminal. Alternatively, after receiving the WiFi-protocol-based packet, the first MAC layer of the first terminal transfers the WiFi-protocol-based packet to the adaptation layer; the adaptation layer converts the WiFi-protocol-based packet into the cellular network packet; the first terminal performs further processing on the cellular network packet inside the first terminal. In this way, the network device sends a downlink packet to the first terminal by using the second terminal.

The embodiments of the present application provide the protocol stack and the communication link establishment method, to establish a security connection between the first terminal and the network device, so that the network device can directly manage the first terminal, for example, the network device can provide a value-added service for the first terminal. The Bluetooth-protocol-based or WiFi-protocol-based communication link between the first terminal and the second terminal can avoid a prior-art process of generating a new packet during packet forwarding by the second terminal, thereby reducing a security risk in a packet transmission process.

For a core network, the protocol stack provided in the embodiments of the present application is equivalent to that the first terminal directly connects to a base station in the network device by using a Uu interface. This can maintain compatibility of the core network. In addition, the network device directly manages the first terminal, and the network device stores information such as a context of the first terminal. Even if a connection between the first terminal and the second terminal is interrupted due to a factor such as a long distance from the second terminal serving as a relay device to the first terminal, the network device can quickly recover a service data transmission capability, thereby reducing complexity of a mobility processing flow, and further reducing a delay.

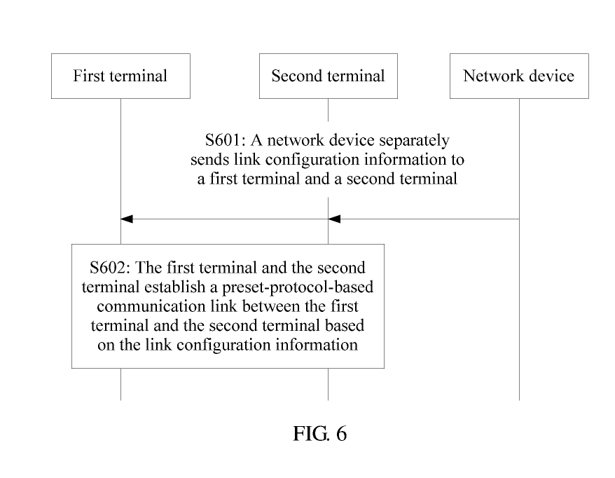

Based on the foregoing embodiments, an embodiment of the present application further provides a first terminal. The first terminal may use the method provided in the embodiment corresponding to the first terminal in FIG. 3. Referring to FIG. 8, a first terminal 800 includes a network connection unit 801, a link establishment unit 802, and a protocol adaptation unit 803, and optionally, further includes a packet transmission unit 804.

The network connection unit 801 is configured to establish a connection between the first terminal and a network device by using a second terminal, where a cellular network communication link has been established between the second terminal and the network device.

The link establishment unit 802 is configured to, after the network connection unit 801 establishes a connection between the first terminal and the network device by using the second terminal, determine link configuration information, and establish, based on the link configuration information, a preset-protocol-based communication link between the first terminal and the second terminal.

The preset protocol is a Bluetooth protocol or a Wireless Fidelity WiFi protocol. The preset-protocol-based communication link and the cellular network communication link are jointly used by the first terminal to transmit a packet with the network device by using the second terminal.

The protocol adaptation unit 803 is configured to, after the link establishment unit 802 establishes the preset-protocol-based communication link between the first terminal and the second terminal, in a process in which the first terminal transmits a packet with the network device by using the second terminal, convert the transmitted packet between a preset-protocol-based packet and a cellular network packet, and transfer the packet inside the first terminal.

Optionally, when determining the link configuration information, the link establishment unit 802 is specifically configured to: receive configuration information that is of a radio bearer and that is sent by the network device, and generate the link configuration information based on the configuration information of the radio bearer, where the radio bearer is a radio bearer between the first terminal and the network device; or receive the link configuration information sent by the network device; or receive the link configuration information sent by the second terminal; or generate the link configuration information based on preconfigured information.

Optionally, the first terminal 800 further includes: the packet transmission unit 804, configured to transmit a packet with the network device by using the second terminal.

Optionally, the packet transmission unit 804 is specifically configured to: convert a cellular network packet generated by a cellular network module into a preset-protocol-based packet; and send the preset-protocol-based packet to the second terminal through the preset-protocol-based communication link, so that after converting the received preset-protocol-based packet into the cellular network packet, the second terminal sends the cellular network packet to the network device through the cellular network communication link.

Optionally, the packet transmission unit 804 is specifically configured to: receive a preset-protocol-based packet of the second terminal through the preset-protocol-based communication link, where the preset-protocol-based packet is obtained by the second terminal by converting a cellular network packet, and the cellular network packet is sent by the network device to the second terminal through the cellular network communication link; and convert the preset-protocol-based packet into the cellular network packet, and transfer the cellular network packet to the cellular network module for processing.

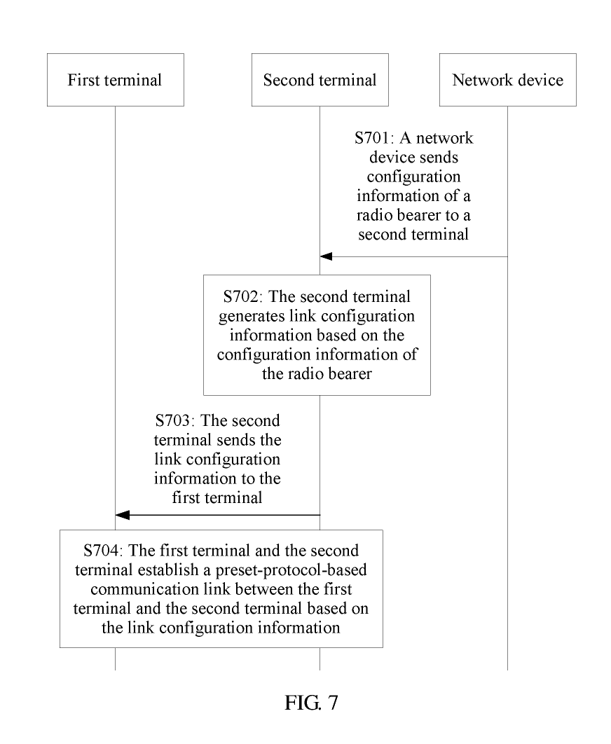

Based on the foregoing embodiments, an embodiment of the present application further provides a network device. The network device may use the method provided in the embodiment corresponding to the network device in FIG. 3. Referring to FIG. 9, a network device 900 includes a network connection unit 901 and a configuration information delivering unit 902, and optionally, further includes a packet transmission unit 903.

The network connection unit 901 is configured to establish a connection between the network device and a first terminal by using a second terminal, where a cellular network communication link has been established between the second terminal and the network device.

The configuration information delivering unit 902 is configured to deliver configuration information after the network connection unit 901 establishes a connection between the network device and the first terminal by using the second terminal, where the configuration information is used to establish a preset-protocol-based communication link between the first terminal and the second terminal.

The preset protocol is a Bluetooth protocol or a Wireless Fidelity WiFi protocol. The preset-protocol-based communication link and the cellular network communication link are jointly used by the first terminal to transmit a packet with the network device by using the second terminal. In a process in which the first terminal transmits a packet with the network device by using the second terminal, the first terminal and the second terminal both have a packet conversion function, and the packet conversion function is to convert the transmitted packet between a preset-protocol-based packet and a cellular network packet.

Optionally, the network connection unit 901 is specifically configured to: receive, by using the second terminal, a request message sent by the first terminal, where the request message is used by the first terminal to request to establish a connection to the network device.

Optionally, the configuration information delivering unit 902 is specifically configured to: send configuration information of a radio bearer separately to the first terminal and the second terminal, where the configuration information of the radio bearer is used to generate link configuration information, the link configuration information is used to establish the preset-protocol-based communication link between the first terminal and the second terminal, and the radio bearer is a radio bearer between the first terminal and the network device; or send configuration information of a radio bearer to the second terminal, where the configuration information of the radio bearer is used to generate link configuration information, the link configuration information is used to establish the preset-protocol-based communication link between the first terminal and the second terminal, and the radio bearer is a radio bearer between the first terminal and the network device; or send link configuration information separately to the first terminal and the second terminal, where the link configuration information is used to establish the preset-protocol-based communication link between the first terminal and the second terminal.

Optionally, the network device 900 further includes: the packet transmission unit 903, configured to transmit a packet with the first terminal by using the second terminal.

Optionally, the packet transmission unit 903 is specifically configured to: receive, through the cellular network communication link, a cellular network packet sent by the second terminal, where the cellular network packet is obtained by the second terminal by converting a preset-protocol-based packet, and the preset-protocol-based packet is sent by the first terminal to the second terminal through the preset-protocol-based communication link; and/or send a cellular network packet to the second terminal through the cellular network communication link, so that the second terminal converts the received cellular network packet into a preset-protocol-based packet, and sends the preset-protocol-based packet to the first terminal through the preset-protocol-based communication link.

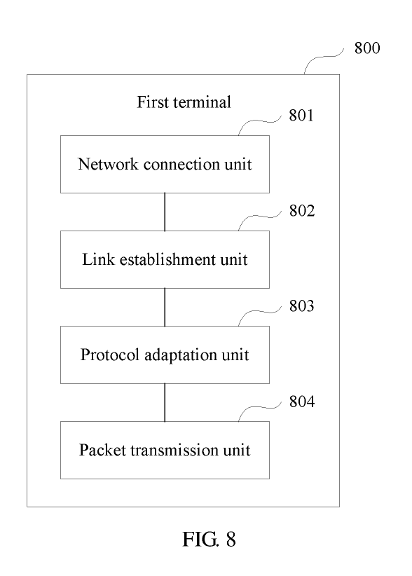

Based on the foregoing embodiments, an embodiment of the present application further provides a second terminal. The second terminal may use the method provided in the embodiment corresponding to the second terminal in FIG. 3. Referring to FIG. 10, a second terminal 1000 includes a network connection determining unit 1001, a link establishment unit 1002, and a protocol adaptation unit 1003, and optionally, further includes a packet transmission unit 1004.

The network connection determining unit 1001 is configured to determine that a first terminal establishes a connection to a network device, where a cellular network communication link has been established between the second terminal and the network device.

The link establishment unit 1002 is configured to, after the network connection determining unit 1001 determines that the first terminal establishes a connection to the network device, determine link configuration information, and establish, based on the link configuration information, a preset-protocol-based communication link between the first terminal and the second terminal.

The preset protocol is a Bluetooth protocol or a Wireless Fidelity WiFi protocol. The preset-protocol-based communication link and the cellular network communication link are jointly used by the first terminal to transmit a packet with the network device by using the second terminal.

The protocol adaptation unit 1003 is configured to, after the link establishment unit 1002 establishes the preset-protocol-based communication link between the second terminal and the first terminal, in a process in which the first terminal transmits a packet with the network device by using the second terminal, convert the transmitted packet between a preset-protocol-based packet and a cellular network packet, and transfer the packet inside the second terminal.

Optionally, when determining the link configuration information, the link establishment unit 1002 is specifically configured to: receive the link configuration information sent by the network device.

Optionally, when determining the link configuration information, the link establishment unit 1002 is specifically configured to: receive configuration information that is of a radio bearer and that is sent by the network device, and generate the link configuration information based on the configuration information of the radio bearer, where the radio bearer is a radio bearer between the first terminal and the network device.

Optionally, the link establishment unit 1002 is further configured to: send the link configuration information to the first terminal.

Optionally, the second terminal woo further includes: a first packet transmission unit 1004, configured to, in the process in which the first terminal transmits a packet with the network device by using the second terminal, receive, through the preset-protocol-based communication link, a preset-protocol-based packet sent by the first terminal; and convert the preset-protocol-based packet into a cellular network packet, and send the cellular network packet to the network device through the cellular network communication link.

Optionally, the second terminal woo further includes: a second packet transmission unit 1004, configured to, in the process in which the first terminal transmits a packet with the network device by using the second terminal, receive, through the cellular network communication link, a cellular network packet sent by the network device; and convert the cellular network packet into a preset-protocol-based packet, and send the preset-protocol-based packet to the first terminal through the preset-protocol-based communication link.

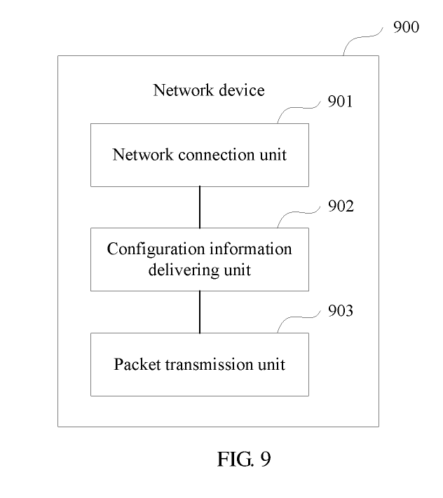

Based on the foregoing embodiments, an embodiment of the present application further provides a network connection determining apparatus that is applied to a first terminal. The first terminal may use the method provided in the embodiment corresponding to the first terminal in FIG. 4. Referring to FIG. 11, a network connection determining apparatus 1100 includes a network identifier obtaining unit 1101 and a network connection determining unit 1102, and optionally, further includes a network connection establishment unit 1103.

The network identifier obtaining unit 1101 is configured to obtain an identifier of a network connected to a second terminal.

The network connection determining unit 1102 is configured to, when the identifier that is obtained by the network identifier obtaining unit 1101 and that is of the network connected to the second terminal is consistent with an identifier of a network to which the first terminal subscribes, determine that the first terminal can establish a connection to a network device by using the second terminal, where the network device is a device in the network connected to the second terminal.

Optionally, the network identifier obtaining unit 1101 is specifically configured to: receive first information broadcast by the second terminal, where the first information includes the identifier of the network connected to the second terminal, and a packet format of the first information is based on a Bluetooth protocol or a Wireless Fidelity WiFi protocol; convert the first information into second information, where a packet format of the second information is based on a cellular network protocol; and obtain, by parsing the second information, the identifier of the network connected to the second terminal.

Optionally, the network connection determining apparatus 1100 further includes: the network connection establishment unit 1103, configured to send a request message to the network device by using the second terminal, where the request message is used by the first terminal to request to establish a connection to the network device.

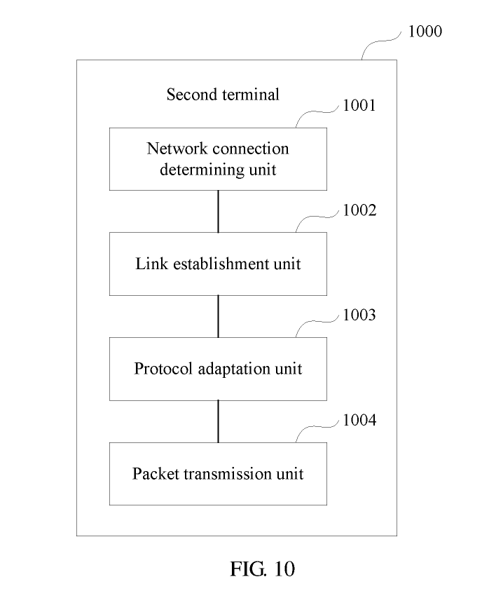

Based on the foregoing embodiments, an embodiment of the present application further provides a network connection determining apparatus that is applied to a second terminal. The second terminal may use the method provided in the embodiment corresponding to the second terminal in FIG. 4. Referring to FIG. 12, a network connection determining apparatus 1200 includes an information determining unit 1201 and an information sending unit 1202, and optionally, further includes a network connection establishment unit 1203.

The information determining unit 1201 is configured to determine first information, where the first information includes an identifier of a network connected to the second terminal, the identifier of the network connected to the second terminal is used by a first terminal to determine that the first terminal can establish a connection to a network device by using the second terminal, and the network device is a device in the network connected to the second terminal.

The information sending unit 1202 is configured to broadcast the first information determined by the information determining unit 1201.

Optionally, the information determining unit 1201 is configured to: receive third information sent by the network device, where the third information includes the identifier of the network connected to the second terminal, and a packet format of the third information is based on a cellular network protocol; and convert the third information into the first information, where a packet format of the first information is based on a Bluetooth protocol or a Wireless Fidelity WiFi protocol.

Optionally, the network connection determining apparatus 1200 further includes: the network connection establishment unit 1203, configured to forward, to the network device, a request message sent by the first terminal, where the request message is used by the first terminal to request to establish a connection to the network device.

It should be noted that unit division in the embodiments of the present application is an example, and is merely logical function division, and there may be another division manner during actual implementation. In addition, functional units in the embodiments of this application may be integrated into one processing unit, or each of the units may exist alone physically, or two or more units are integrated into one unit. The integrated unit may be implemented in a form of hardware, or may be implemented in a form of a software functional unit.

When the integrated unit is implemented in software, and is sold or used as an independent product, the integrated unit may be stored in a computer readable storage medium. Based on such understanding, some or all aspects of the embodiments described above may be represented in a form of a software product. The computer software product is stored in a storage medium, and includes a plurality of instructions used to enable one computer device (which may be a personal computer, a server, a network device, or the like) or a processor to perform all or some steps of the method in the embodiments of the present application. The foregoing storage medium includes any medium that can store program code, such as a USB flash drive, a removable hard disk, a read-only memory (ROM), a random access memory (RAM), a magnetic disk, or a compact disc.

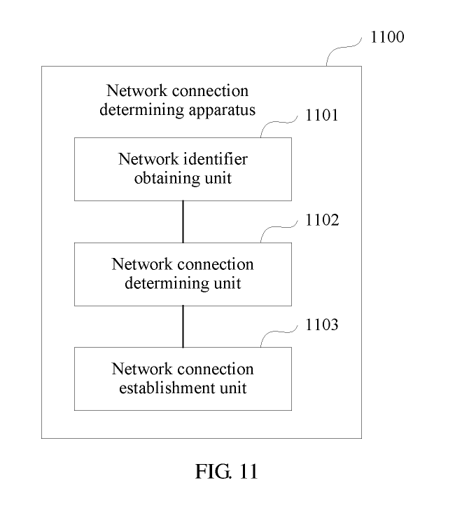

Based on the foregoing embodiments, the present application further provides a first terminal. The first terminal may use the method provided in the embodiment corresponding to the first terminal in FIG. 3 or FIG. 4, and may be a device that is the same as a first terminal apparatus shown in FIG. 8 or FIG. 11. Referring to FIG. 13, a first terminal 1300 includes a processor 1301, a transceiver 1302, a bus 1303, and a memory 1304.

The processor 1301, the transceiver 1302, and the memory 1304 are interconnected by using the bus 1303. The bus 1303 may be a peripheral component interconnect (PCI) bus, an extended industry standard architecture (EISA) bus, or the like. The bus may be divided into an address bus, a data bus, a control bus, or the like. For ease of description, in FIG. 13, only one bold line is used for representation, but it does not mean that there is only one bus or one type of bus.

The processor 1301 in the first terminal 1300 corresponds to a unit having a processing function in the first terminal. The transceiver 1302 corresponds to a unit having a data receiving or sending function in the first terminal. The memory 1304 is configured to store a program and the like. Specifically, the program may include program code, and the program code includes a computer operation instruction. The memory 1304 may include a random access memory (RAM), or may include a non-volatile memory, for example, at least one magnetic disk memory. The processor 1301 executes the application program stored in the memory 1304, to implement the foregoing communication link establishment method.

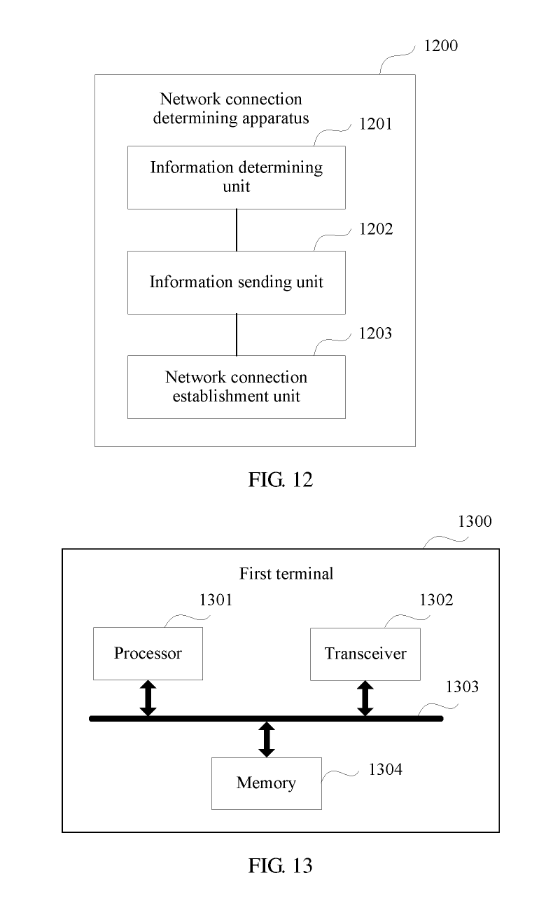

Based on the foregoing embodiments, the present application further provides a network device. The network device may use the method provided in the embodiment corresponding to the network device in FIG. 3, and may be a device that is the same as the network device shown in FIG. 9. Referring to FIG. 14, a network device 1400 includes a processor 1401, a transceiver 1402, a bus 1403, and a memory 1404.

The processor 1401, the transceiver 1402, and the memory 1404 are interconnected by using the bus 1403. The bus 1403 may be a PCI bus, an EISA bus, or the like. The bus may be divided into an address bus, a data bus, a control bus, or the like. For ease of description, in FIG. 14, only one bold line is used for representation, but it does not mean that there is only one bus or one type of bus.

The processor 1401 in the network device 1400 corresponds to a unit having a processing function in the network device. The transceiver 1402 corresponds to a unit having a data receiving or sending function in the network device. The memory 1404 is configured to store a program and the like. Specifically, the program may include program code, and the program code includes a computer operation instruction. The memory 1404 may include a RAM, or may include a non-volatile memory, for example, at least one magnetic disk memory. The processor 1401 executes the application program stored in the memory 1404, to implement the foregoing communication link establishment method.

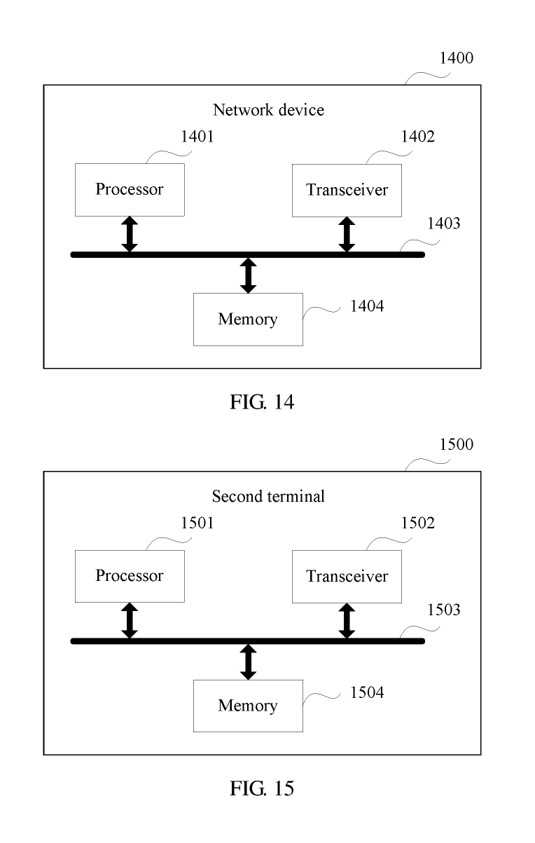

Based on the foregoing embodiments, the present application further provides a second terminal. The second terminal may use the method provided in the embodiment corresponding to the second terminal in FIG. 3 and/or FIG. 4, and may be a device that is the same as a second terminal apparatus shown in FIG. 10 and/or FIG. 12. Referring to FIG. 15, a second terminal 1500 includes a processor 1501, a transceiver 1502, a bus 1503, and a memory 1504.

The processor 1501, the transceiver 1502, and the memory 1504 are interconnected by using the bus 1503. The bus 1503 may be a PCI bus, an EISA bus, or the like. The bus may be divided into an address bus, a data bus, a control bus, or the like. For ease of description, in FIG. 15, only one bold line is used for representation, but it does not mean that there is only one bus or one type of bus.

The processor 1501 in the second terminal 1500 corresponds to a unit having a processing function in the second terminal. The transceiver 1502 corresponds to a unit having a data receiving or sending function in the second terminal. The memory 1504 is configured to store a program and the like. Specifically, the program may include program code, and the program code includes a computer operation instruction. The memory 1504 may include a RAM, or may include a non-volatile memory, for example, at least one magnetic disk memory. The processor 1501 executes the application program stored in the memory 1504, to implement the foregoing communication link establishment method.

Although some preferred embodiments of the present application have been described, a person skilled in the art can make changes and modifications to these embodiments once they learn the basic inventive concept. Therefore, the following claims are intended to be construed as to cover the preferred embodiments and all changes and modifications falling within the scope of the present application.

Obviously, a person skilled in the art can make various modifications and variations to the embodiments of the present application without departing from the spirit and scope of the embodiments of the present application. The present application is intended to cover these modifications and variations provided that they fall within the scope of protection defined by the following claims and their equivalent technologies.

What is claimed is:

1. A communication link establishment method comprising:
establishing, by a first terminal, a connection to a network device by using a second terminal, wherein the connection establishes a cellular network communication link between the second terminal and the network device; and
determining, by the first terminal, link configuration information;
establishing, based on the link configuration information, a preset-protocol-based communication link with the second terminal using a preset protocol, wherein the preset protocol is a Bluetooth protocol or a Wireless Fidelity (WiFi) protocol, and the preset-protocol-based communication link and the cellular network communication link are jointly used by the first terminal and the second terminal to transmit a packet to the network device; and
wherein transmitting the packet to the network device by using the second terminal comprises converting the transmitted packet between a preset-protocol-based packet and a cellular network packet at the first terminal and the second terminal.

2. The method according to claim 1, wherein determining the link configuration information comprises:
receiving, by the first terminal, configuration information that is of a radio bearer and that is sent by the network device, and generating, by the first terminal, the link configuration information based on the configuration information of the radio bearer, wherein the radio bearer is a radio bearer between the first terminal and the network device; or
receiving, by the first terminal, the link configuration information sent by the network device; or
receiving, by the first terminal, the link configuration information sent by the second terminal; or
generating, by the first terminal, the link configuration information based on preconfigured information.

3. The method according to claim 1, after establishing the preset-protocol-based communication link, the method further comprises:
transmitting, by the first terminal, a packet to the network device by using the second terminal.

4. The method according to claim 3, wherein transmitting the packet to the network device by using the second terminal comprises:
converting, by the first terminal, a cellular network packet generated by a cellular network module into a preset-protocol-based packet; and
sending, by the first terminal, the preset-protocol-based packet to the second terminal through the preset-protocol-based communication link.

5. The method according to claim 3, wherein the transmitting the packet to the network device by using the second terminal comprises:
receiving, by the first terminal, a preset-protocol-based packet of the second terminal through the preset-protocol-based communication link, wherein the preset-protocol-based packet is obtained by the second terminal by converting a cellular network packet, and the cellular network packet is sent by the network device to the second terminal through the cellular network communication link; and
converting, by the first terminal, the preset-protocol-based packet into the cellular network packet, and transferring the cellular network packet to the cellular network for processing.

6. A communication link establishment method, comprising:
establishing, by a network device, a connection to a first terminal by using a second terminal, wherein the connection establishes a cellular network communication link between the second terminal and the network device; and
delivering, by the network device, configuration information, wherein the configuration information is used to establish a preset-protocol-based communication link between the first terminal and the second terminal using a preset protocol, wherein the preset protocol is a Bluetooth protocol or a Wireless Fidelity (WiFi) protocol, and the preset-protocol-based communication link and the cellular network communication link are jointly used by the first terminal and the second terminal to transmit a packet to the network device; and
wherein transmitting the packet to the network device comprises converting the transmitted packet between a preset-protocol-based packet and a cellular network packet at the first terminal and the second terminal.

7. The method according to claim 6, wherein establishing the connection to the first terminal by using the second terminal comprises:
receiving, by the network device by using the second terminal, a request message sent by the first terminal, wherein the request message is used by the first terminal to request to establish a connection to the network device.

8. The method according to claim 6, wherein delivering the configuration information comprises:
sending, by the network device, configuration information of a radio bearer separately to the first terminal and the second terminal, wherein the configuration information of the radio bearer is used to generate link configuration information, the link configuration information is used to establish the preset-protocol-based communication link between the first terminal and the second terminal, and the radio bearer is a radio bearer between the first terminal and the network device; or
sending, by the network device, configuration information of a radio bearer to the second terminal, wherein the configuration information of the radio bearer is used to generate link configuration information, the link configuration information is used to establish the preset-protocol-based communication link between the first terminal and the second terminal, and the radio bearer is a radio bearer between the first terminal and the network device; or
sending, by the network device, link configuration information separately to the first terminal and the second terminal, wherein the link configuration information is used to establish the preset-protocol-based communication link between the first terminal and the second terminal.

9. The method according to claim 6, further comprising:
transmitting, by the network device, a packet to the first terminal by using the second terminal.

10. The method according to claim 9, wherein transmitting the packet to the first terminal by using the second terminal comprises:
receiving, by the network device through the cellular network communication link, a cellular network packet sent by the second terminal, wherein the cellular network packet is obtained by the second terminal by converting a preset-protocol-based packet, and the preset-protocol-based packet is sent by the first terminal to the second terminal through the preset-protocol-based communication link; or
sending, by the network device, a cellular network packet to the second terminal through the cellular network communication link.

11. A network protocol stack comprising:
a first terminal protocol stack comprising a cellular network Packet Data Convergence Protocol (PDCP) layer, an adaptation layer, and a preset protocol stack that are successively arranged from an upper layer to a bottom layer, wherein the preset protocol stack is based on a Bluetooth protocol or a Wireless Fidelity WiFi protocol, wherein the protocol stack is applied to a system in which a first terminal connects to a network device by using a second terminal;
a second terminal protocol stack comprising a first protocol stack on a first interface side between the second terminal and the first terminal and a second protocol stack on a second interface side between the second terminal and the network device, the first protocol stack on the first interface side comprises an adaptation layer and a preset protocol stack that are successively arranged from an upper layer to a bottom layer and that are peering to the first terminal protocol stack, the second protocol stack on the second interface side comprises a second Radio Link Control (RLC) layer, a second Media Access Control (MAC) layer, and a second physical PHY layer that are successively arranged from an upper layer to a bottom layer; and
a network device protocol stack comprising a cellular network PDCP layer that is peering to the first terminal protocol stack and a second RLC layer, a second MAC layer, and a second PHY layer that are peering to the second protocol stack on the second interface side, wherein the cellular network PDCP layer, the second RLC layer, the second MAC layer, and the second PHY layer are successively arranged from an upper layer to a bottom layer; and
in response to determining that the network protocol stack comprises a control plane protocol stack, a cellular network radio resource control RRC layer is arranged above the cellular network PDCP layer of the first terminal protocol stack, and a cellular network RRC layer that is peering to the first terminal protocol stack is arranged above the cellular network PDCP layer of the network device protocol stack.

12. The protocol stack according to claim 11, wherein the first terminal transmits a packet with the second terminal through a preset-protocol-based communication link, wherein the preset protocol is a Bluetooth protocol or a WiFi protocol;
wherein a cellular network RLC layer is arranged between the cellular network PDCP layer and the adaptation layer in the first terminal protocol stack; and
wherein a cellular network RLC layer that is peering to the first terminal protocol stack is arranged below the cellular network PDCP layer in the network device protocol stack.

13. The protocol stack according to claim 11, wherein the adaptation layer is configured to:
implement a function of converting a packet between a preset-protocol-based packet and a cellular network packet; and
implement a function of configuring parameter information of the preset protocol stack.

14. The protocol stack according to claim 11, wherein the second terminal transmits a packet with the network device through a cellular network communication link;
wherein a second PDCP layer is arranged above the second RLC layer of the second terminal protocol stack; and
wherein another second PDCP layer that is peering to the second terminal protocol stack is arranged between the cellular network PDCP layer and the second RLC layer of the network device protocol stack, wherein the second PDCP layer is configured to implement a function of packet security processing negotiated between the second terminal and the network device.

15. The protocol stack according to claim 14, wherein the adaptation layer in the protocol stack on the first interface side is configured to implement a function of transmitting a packet with the second PDCP layer or the second RLC layer in the protocol stack on the second interface side.

16. The protocol stack according to claim 11, wherein
the preset protocol stack is based on a Bluetooth protocol, and the preset protocol stack has a Logical Link Control and Adaptation Protocol L2CAP layer and a first PHY layer that are successively arranged from an upper layer to a bottom layer; or
the preset protocol stack is based on a WiFi protocol, and the preset protocol stack has a first MAC layer and a first PHY layer that are successively arranged from an upper layer to a bottom layer.

17. A first terminal comprising:
a processor;
a memory storing a program to be executed in the processor and comprising instructions for:
establishing, by the first terminal, a connection to a network device by using a second terminal, wherein the connection establishes a cellular network communication link between the second terminal and the network device; and
determining, by the first terminal, link configuration information; and
establishing, based on the link configuration information, a preset-protocol-based communication link with the second terminal using a preset protocol, wherein the preset protocol is a Bluetooth protocol or a Wireless Fidelity (WiFi) protocol, and the preset-protocol-based communication link and the cellular network communication link are jointly used by the first terminal and the second terminal to transmit a packet to the network device, wherein transmitting the packet to the network device by using the second terminal comprises converting the transmitted packet between a preset-protocol-based packet and a cellular network packet at the first terminal and the second terminal and transferring the packet inside the first terminal.

18. The first terminal according to claim 17, wherein when determining the link configuration information, the program comprises further instructions for
receiving configuration information that is of a radio bearer and that is sent by the network device, and generating the link configuration information based on the configuration information of the radio bearer, wherein the radio bearer is a radio bearer between the first terminal and the network device; or
receiving the link configuration information sent by the network device; or
receiving the link configuration information sent by the second terminal; or
generating the link configuration information based on preconfigured information.

19. The first terminal according to claim 17, wherein the program comprises further instructions for
transmitting a packet to the network device by using the second terminal.

20. The first terminal according to claim 19, wherein transmitting a packet to the network device by using the second terminal comprises:
converting a cellular network packet generated by a cellular network module into a preset-protocol-based packet; and
sending the preset-protocol-based packet to the second terminal through the preset-protocol-based communication link.
